(19) United States
(12) Patent Application Publication
(10) Pub. No.: US 2015/0177903 A1
(43) Pub. Date: Jun. 25, 2015

(54) METHOD AND APPARATUS FOR CONTROLLING SCALE RESOLUTION IN ELECTRONIC DEVICE

(71) Applicant: Samsung Electronics Co., Ltd., Suwon-si (KR)

(72) Inventors: Soohyung KIM, Hwaseong-si (KR); Hyunsoo KIM, Yongin-si (KR); Sungho SON, Daegu (KR); Sunghyuk SHIN, Seongnam-si (KR); Huncheol OH, Seoul (KR); Jinhong JEONG, Yongin-si (KR)

(21) Appl. No.: 14/565,891

(22) Filed: Dec. 10, 2014

(30) Foreign Application Priority Data
Dec. 20, 2013 (KR) 10-2013-0160281

(51) Int. Cl. G06F 3/041; G06F 3/0354; G06F 3/01

(52) U.S. Cl. CPC G06F 3/0416; G06F 3/017; G06F 3/03545; G06F 3/0414

(57) ABSTRACT

A method and apparatus that control scale resolution according to various types of information extracted from distinct input means in an electronic device is provided. The method includes presenting information on a display module functionally connected to the electronic device, detecting a first user input related to the presented information, determining scale resolution based at least in part on the first user input, and executing, upon detection of a second user input, a preset function based at least in part on the second user input and the scale resolution.

### CROSS-REFERENCE TO RELATED APPLICATION(S)

This application claims the benefit under 35 U.S.C. §119(a) of a Korean patent application filed on Dec. 20, 2013 in the Korean Intellectual Property Office and assigned Serial number 10-2013-0160281, the entire disclosure of which is hereby incorporated by reference.

### TECHNICAL FIELD

The present disclosure relates to a method and apparatus that control scale resolution according to various types of information extracted from distinct input means in an electronic device.

### BACKGROUND

Portable electronic devices that are carried by users have various restrictions in terms of size and weight. For example, an electronic device that is too heavy or too large cannot be carried by a user. As a portable electronic device uses a battery as a primary power source, usage of low-power circuits is required.

Because of size and weight restrictions, user input techniques for electronic devices have also been developed to support portability. For example, composite function key input (e.g., enabling invocation of multiple distinct functions), touch input, pen input and sensor input may be used as input means for portable electronic devices. Currently, various types of portable electronic devices, such as a mobile terminal, smartphone, digital camcorder, smart terminal and tablet computer, are commercially available.

However, user input means for a portable electronic device such as a touch gesture, pen and sensor are used in a very restrictive manner. Hence, a scheme that enables a user to use more diverse input means to control an electronic device is desired.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method and apparatus that control scale resolution according to various user inputs in an electronic device.

Another aspect of the present disclosure is to provide an input method and apparatus that can be used in various ways according to various user inputs in an electronic device.

In accordance with an aspect of the present disclosure, a method for controlling an electronic device is provided. The method includes presenting information on a display module functionally connected to the electronic device, detecting a first user input related to the presented information, determining a scale resolution based at least in part on the first user input, and executing, upon detection of a second user input, a preset function based at least in part on the second user input and the scale resolution.

In accordance with another aspect of the present disclosure, an electronic device is provided. The electronic device includes a display module configured to display states of the electronic device and screen data of an executed program, a user input module configured to detect a first user input and a second user input associated with information presented on the display module, a memory module configured to store control data and user data, and a processor configured to perform a process of determining, when the first user input is detected from the user input module, scale resolution based at least in part on the first user input, and executing, when the second user input is detected, a preset function.

In accordance with another aspect of the present disclosure, a method and apparatus enable an electronic device to utilize various user inputs in various ways. In addition, the method and apparatus enable an electronic device to control scale resolution according to various user inputs.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating a configuration of an electronic device according to an embodiment of the present disclosure;

FIG. 2 is a block diagram illustrating a configuration of hardware according to an embodiment of the present disclosure;

FIG. 3 is a block diagram illustrating a configuration of a programming module according to an embodiment of the present disclosure;

FIG. 4 is a flowchart of a method for controlling scale resolution in response to various user inputs in an electronic device according to an embodiment of the present disclosure;

FIG. 5A illustrates one of various user input schemes according to an embodiment of the present disclosure;

FIG. 5B illustrates another one of various user input schemes according to an embodiment of the present disclosure;

FIG. 6A illustrates variations in one dimensional scale resolution according to an embodiment of the present disclosure;

FIG. 6B illustrates pen movement along with variations in one dimensional scale resolution according to an embodiment of the present disclosure;

FIG. 6C illustrates movement in a video file along with variations in scale resolution according to an embodiment of the present disclosure;

FIG. 6D illustrates variations of scale resolution in response to user input in a video maker edit mode according to an embodiment of the present disclosure;

FIG. 6E illustrates variations of scale resolution in response to user input in a video maker edit mode according to an embodiment of the present disclosure;

FIG. 6F illustrates temporal variations in scale resolution along with pen pressure and movement in a music player seek mode according to an embodiment of the present disclosure;

FIG. 6G illustrates frame search during video file playback according to an embodiment of the present disclosure;

FIG. 6H illustrates frame search during music file playback according to an embodiment of the present disclosure;

FIG. 6I illustrates temporal variations of scale resolution in response to a user input in a voice recorder mode according to an embodiment of the present disclosure;

FIG. 6J illustrates scroll bar control in response to a user input according to an embodiment of the present disclosure;

FIG. 6K illustrates zooming operation control in response to a user input in a camera capture mode according to an embodiment of the present disclosure;

FIG. 6L illustrates variations of scale resolution in response to a user input in a clock display mode according to an embodiment of the present disclosure;

FIG. 6M illustrates an English search mode change in response to a user input according to an embodiment of the present disclosure;

FIG. 6N illustrates variations of scale resolution in an English search along with pressure according to an embodiment of the present disclosure;

FIG. 6O illustrates variations of scale resolution in a Hangul search along with pressure according to an embodiment of the present disclosure;

FIG. 7A illustrates variations in two dimensional scale resolution along with a touch according to an embodiment of the present disclosure;

FIG. 7B illustrates variations of two dimensional scale resolution in response to a user input during photograph previewing according to an embodiment of the present disclosure;

FIG. 7C illustrates variations of two dimensional scale resolution in response to a user input during photograph viewing according to an embodiment of the present disclosure;

FIG. 7D illustrates variations of two dimensional scale resolution in response to a user input during music search according to an embodiment of the present disclosure;

FIG. 7E illustrates variations of two dimensional scale resolution in response to a user input during music search according to an embodiment of the present disclosure; and

FIG. 7F illustrates variations of two dimensional scale resolution in response to a user input during folder search according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings. Rather, the terms and words are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The expressions such as “include” and “may include” which may be used in the present disclosure denote the presence of the disclosed functions, operations, and constituent elements and do not limit one or more additional functions, operations, and constituent elements. In the present disclosure, the terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

Furthermore, in the present disclosure, the expression “and/or” includes any and all combinations of the associated listed words. For example, the expression “A and/or B” may include A, may include B, or may include both A and B.

In the present disclosure, expressions including ordinal numbers, such as “first” and “second,” or the like, may modify various elements. However, such elements are not limited by the above expressions. For example, the above expressions do not limit the sequence and/or importance of the elements. The above expressions are used merely for the purpose to distinguish an element from the other elements. For example, a first user device and a second user device indicate different user devices although both of them are user devices. For example, a first element could be termed a second element, and similarly, a second element could be also termed a first element without departing from the scope of the present disclosure.

In the case in which a component is referred to as being “connected” or “accessed” to other component, it should be understood that not only the component is directly connected or accessed to the other component, but also there may exist another component between them. Meanwhile, in the case in which a component is referred to as being “directly connected” or “directly accessed” to other component, it should be understood that there is no component therebetween. The terms used in the present disclosure are only used to describe specific various embodiments, and are not intended to limit the present disclosure. As used herein, the singular forms are intended to include the plural forms as well, unless the context clearly indicates otherwise. Singular forms are intended to include plural forms unless the context clearly indicates otherwise.

According to various embodiments of the present disclosure, an electronic device may be a device including a communication function. For example, the device may correspond to a combination of at least one of a smartphone, a tablet Personal Computer (PC), a mobile phone, a video phone, an e-book reader, a desktop PC, a laptop PC, a netbook computer, a Personal Digital Assistant (PDA), a Portable Multimedia Player (PMP), a digital audio player, a mobile medical device, an electronic bracelet, an electronic necklace, an electronic accessory, a camera, a wearable device, an electronic clock, a wrist watch, home appliances (e.g., an air-conditioner, vacuum, an oven, a microwave, a washing machine, an air cleaner, and the like), an artificial intelligence robot, a TeleVision (TV), a Digital Video Disk (DVD) player, an audio device, various medical devices (e.g., Magnetic Resonance Angiography (MRA), Magnetic Resonance Imaging (MRI), Computed Tomography (CT), a scanning machine, a ultrasonic wave device, or the like), a navigation device, a Global Positioning System (GPS) receiver, an Event Data Recorder (EDR), a Flight Data Recorder (FDR), a set-top box, a TV box (e.g., Samsung HomeSync™, Apple TV™, or Google TV™), an electronic dictionary, vehicle infotainment device, an electronic equipment for a ship (e.g., navigation equipment for a ship, gyrocompass, or the like), avionics, a security device, electronic clothes, an electronic key, a camcorder, game consoles, a Head-Mounted Display (HMD), a flat panel display device, an electronic frame, an electronic album, furniture or a portion of a building/structure that includes a communication function, an electronic board, an electronic signature receiving device, a projector, and the like. The electronic device according to the present disclosure is not limited to the aforementioned devices.

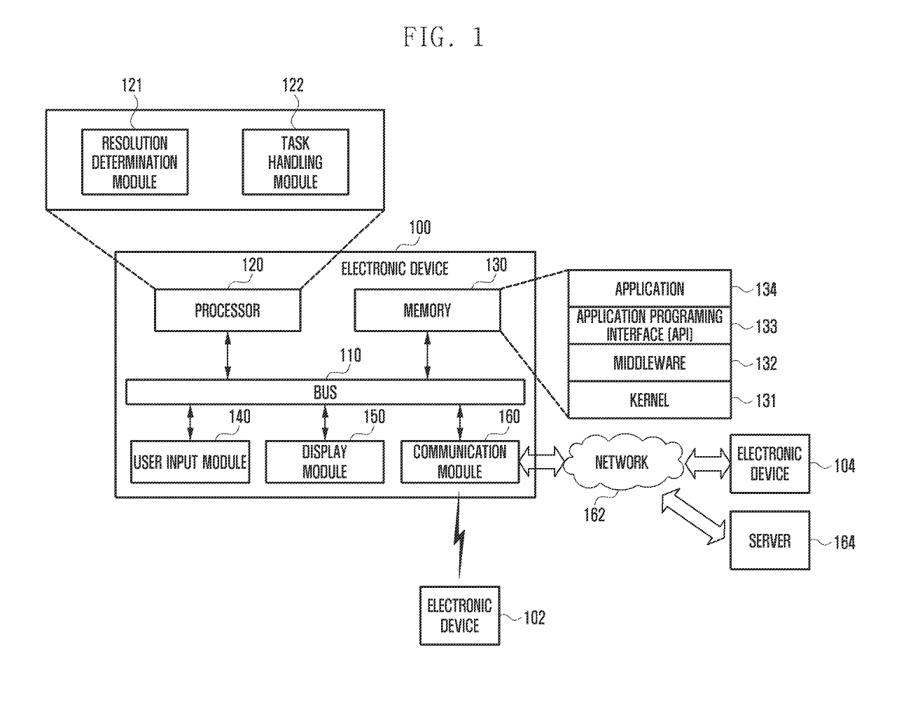

FIG. 1 is a block diagram illustrating a configuration of an electronic device according to an embodiment of the present disclosure.

Referring to FIG. 1, the electronic device 100 may include a bus 110, a processor 120, a memory 130, a user input module 140, a display module 150, a communication module 160, and other similar and/or suitable components.

The bus 110 may be a circuit which interconnects elements of the electronic device (e.g., the above-described elements) and delivers a communication (e.g., a control message) between the above-described elements.

The processor 120 may receive commands from the above-described other elements (e.g., the memory 130, the user input module 140, the display module 150, the communication module 160, and/or the like) through the bus 110, may interpret the received commands, and may execute calculation or data processing according to the interpreted commands.

In addition, the processor 120 may include a resolution determination module 121 and a task handling module 122. The resolution determination module 121 may determine scale resolution in response to, for example, vertical input among various user input schemes. Vertical input or input in the vertical direction may correspond to an input level of at least one of a hovering separation distance, a pressure, a writing pressure at a touched state, a pressure of the hand (e.g., the user's hand), and area of the hand. In the following description, vertical input detected by the resolution determination module 121 is referred to as a primary user input or a first user input.

The task handling module 122 may perform a specific action mapped with a secondary user input or a second user input (e.g., pen movement, hand movement, pupil movement, gesture input, tilting, panning, tapping, dragging, and/or the like) detected after detection of the primary user input or the first user input. For example, the mapped action may correspond to one of screen enlargement/reduction, movement on the time search bar of a video player, movement on the time search bar of a music player, movement of preview frames in a video maker, enlargement/reduction, scrolling, volume adjustment, brightness adjustment, depth adjustment in character search, scrolling files in a folder, zoom in/out in a camera, fast-forward/rewind, and/or the like.

The memory 130 may store commands or data received from the processor 120 or other elements (e.g., the user input module 140, the display module 150, the communication module 160, and/or the like) or generated by the processor 120 or the other elements. The memory 130 may include programming modules, such as a kernel 131, middleware 132, an Application Programming Interface (API) 133, an application 134, and the like. Each of the above-described programming modules may be implemented in software, firmware, hardware, or a combination of two or more thereof.

The kernel 131 may control or manage system resources (e.g., the bus 110, the processor 120, the memory 130, and/or the like) used to execute operations or functions implemented by other programming modules (e.g., the middleware 132, the API 133, and the application 134). The kernel 131 may provide an interface capable of accessing and controlling or managing the individual elements of the electronic device 100 by using the middleware 132, the API 133, or the application 134.

The middleware 132 may serve to go between the API 133 or the application 134 and the kernel 131 in such a manner that the API 133 or the application 134 communicates with the kernel 131 and exchanges data therewith. In relation to work requests received from one or more applications 134 and/or the middleware 132, for example, may perform load balancing of the work requests by using a method of assigning a priority, in which system resources (e.g., the bus 110, the processor 120, the memory 130, and/or the like) of the electronic device 100 can be used, to at least one of the one or more applications 134.

The API 133 is an interface through which the application 134 is capable of controlling a function provided by the kernel 131 or the middleware 132, and may include, for example, at least one interface or function for file control, window control, image processing, character control, or the like.

The user input module 140, for example, may receive a command or data as input from a user, and may deliver the received command or data to the processor 120 or the memory 130 through the bus 110. As described before, the user input module 140 may detect two or more types of user input. For example, the user input module 140 may detect writing pressure at a touched state, pressure of the hand, hand area change or hovering level as the primary user input or the first user input, and may detect a pen movement, a hand movement, a pupil movement, a gesture input, a tilting, a panning, a tapping, or a dragging as the secondary user input or the second user input.

When the first user input or the primary user input detected by the user input module 140 is writing pressure of a pen, the second user input or the secondary user input may be a pen movement. The writing pressure of the pen and movement of the pen may be orthogonal to each other. For example, writing pressure of the pen corresponds to a pressing force in the direction of the user input module 140, and movement of the pen corresponds to movement in the upward/downward/left/right direction on the user input module 140 with contact maintained. Hence, the two types of user input may be orthogonal to each other.

The display module 150 may display a video, an image, data, or the like to the user.

The communication module 160 may connect communication between another electronic device 102 and the electronic device 100. The communication module 160 may support a predetermined short-range communication protocol (e.g., Wi-Fi, BlueTooth (BT), and Near Field Communication (NFC)), or predetermined network communication 162 (e.g., the Internet, a Local Area Network (LAN), a Wide Area Network (WAN), a telecommunication network, a cellular network, a satellite network, a Plain Old Telephone Service (POTS), or the like). Each of the electronic devices 102 and 104 may be a device which is identical (e.g., of an identical type) to or different (e.g., of a different type) from the electronic device 100. Further, the communication module 160 may connect communication between a server 164 and the electronic device 100 via the network 162.

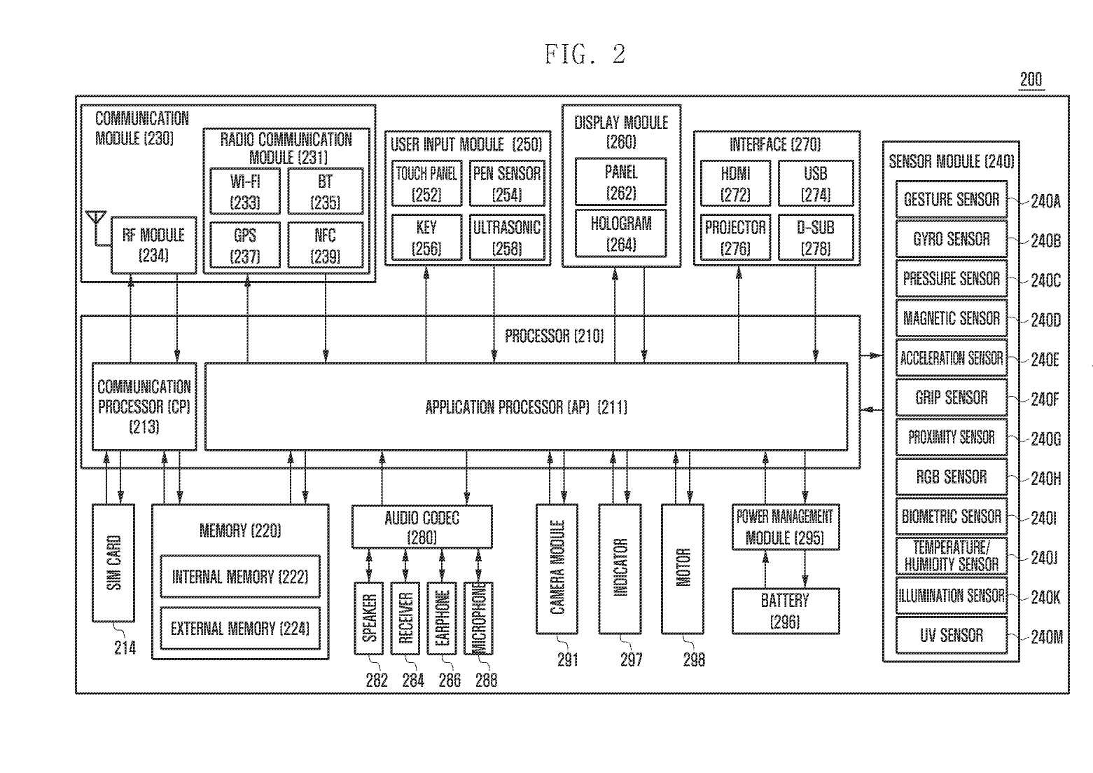

FIG. 2 is a block diagram illustrating a configuration of hardware according to an embodiment of the present disclosure.

The hardware 200 may be, for example, the electronic device 100 illustrated in FIG. 1.

Referring to FIG. 2, the hardware 200 may include one or more processors 210, a Subscriber Identification Module (SIM) card 214, a memory 220, a communication module 230, a sensor module 240, a user input module 250, a display module 260, an interface 270, an audio coder/decoder (codec) 280, a camera module 291, a power management module 295, a battery 296, an indicator 297, a motor 298 and any other similar and/or suitable components.

The processor 210 (e.g., the processor 120) may include one or more Application Processors (APs) 211, or one or more Communication Processors (CPs) 213. The processor 210 may be, for example, the processor 120 illustrated in FIG. 1. The AP 211 and the CP 213 are illustrated as being included in the processor 210 in FIG. 2, however, the AP 211 and the CP 213 may be included in different Integrated Circuit (IC) packages, respectively. According to an embodiment of the present disclosure, the AP 211 and the CP 213 may be included in one IC package.

The AP 211 may execute an Operating System (OS) or an application program, and thereby may control multiple hardware or software elements connected to the AP 211 and may perform processing of and arithmetic operations on various data including multimedia data. The AP 211 may be implemented by, for example, a System on Chip (SoC). According to an embodiment of the present disclosure, the processor 210 may further include a Graphical Processing Unit (GPU) (not illustrated).

The CP 213 may manage a data line and may convert a communication protocol in the case of communication between the electronic device (e.g., the electronic device 100) including the hardware 200 and different electronic devices connected to the electronic device through the network. The CP 213 may be implemented by, for example, a SoC. According to an embodiment of the present disclosure, the CP 213 may perform at least some of multimedia control functions. The CP 213, for example, may distinguish and authenticate a terminal in a communication network by using a subscriber identification module (e.g., the SIM card 214). The CP 213 may provide the user with services, such as a voice telephony call, a video telephony call, a text message, packet data, and the like.

Further, the CP 213 may control the transmission and reception of data by the communication module 230. In FIG. 2, the elements such as the CP 213, the power management module 295, the memory 220, and the like are illustrated as elements separate from the AP 211. However, according to an embodiment of the present disclosure, the AP 211 may include at least some (e.g., the CP 213) of the above-described elements.

According to an embodiment of the present disclosure, the AP 211 or the CP 213 may load, to a volatile memory, a command or data received from at least one of a non-volatile memory and other elements connected to each of the AP 211 and the CP 213, and may process the loaded command or data. The AP 211 and/or the CP 213 may store, in a non-volatile memory, data received from or generated by at least one of the other elements.

The SIM card 214 may be a card implementing a subscriber identification module, and may be inserted into a slot formed in a particular portion of the electronic device 100. The SIM card 214 may include unique identification information (e.g., Integrated Circuit Card IDentifier (ICCID)) or subscriber information (e.g., International Mobile Subscriber Identity (IMSI)).

The memory 220 may include an internal memory 222 and an external memory 224. The memory 220 may be, for example, the memory 130 illustrated in FIG. 1. The internal memory 222 may include, for example, at least one of a volatile memory (e.g., a Dynamic RAM (DRAM), a Static RAM (SRAM), a Synchronous Dynamic RAM (SDRAM), and/or the like), and a non-volatile memory (e.g., a One Time Programmable ROM (OTPROM), a Programmable ROM (PROM), an Erasable and Programmable ROM (EPROM), an Electrically Erasable and Programmable ROM (EEPROM), a mask ROM, a flash ROM, a Not AND (NAND) flash memory, a Not OR (NOR) flash memory, and/or the like). According to an embodiment of the present disclosure, the internal memory 222 may be in the form of a Solid State Drive (SSD). The external memory 224 may further include a flash drive, for example, a Compact Flash (CF), a Secure Digital (SD), a Micro-Secure Digital (Micro-SD), a Mini-Secure Digital (Mini-SD), an extreme Digital (xD), a memory stick, and/or the like.

The communication module 230 may include a wireless communication module 231 or a Radio Frequency (RF) module 234. The communication module 230 may be, for example, the communication module 160 illustrated in FIG. 1. The wireless communication module 231 may include, for example, a Wi-Fi module 233, a BT module 233, a GPS module 237, or a NFC module 239. For example, the wireless communication module 231 may provide a wireless communication function by using a radio frequency. Additionally or alternatively, the wireless communication module 231 may include a network interface (e.g., a LAN card), a modulator/demodulator (modem), or the like for connecting the hardware 200 to a network (e.g., the Internet, a LAN, a WAN, a telecommunication network, a cellular network, a satellite network, a POTS, or the like).

The RF module 234 may be used for transmission and reception of data, for example, transmission and reception of RF signals or called electronic signals. Although not illustrated, the RF unit 234 may include, for example, a transceiver, a Power Amplifier Module (PAM), a frequency filter, a Low Noise Amplifier (LNA), or the like. The RF module 234 may further include a component for transmitting and receiving electromagnetic waves in a free space in a wireless communication, for example, a conductor, a conductive wire, or the like.

The sensor module 240 may include, for example, at least one of a gesture sensor 240A, a gyro sensor 240B, an atmospheric pressure sensor 240C, a magnetic sensor 240D, an acceleration sensor 240E, a grip sensor 240F, a proximity sensor 240G, a Red, Green and Blue (RGB) sensor 240H, a biometric sensor 240I, a temperature/humidity sensor 240J, an illuminance sensor 240K, and a Ultra Violet (UV) sensor 240M. The sensor module 240 may measure a physical quantity or may detect an operating state of the electronic device 100, and may convert the measured or detected information to an electrical signal. Additionally or alternatively, the sensor module 240 may include, for example, an E-nose sensor (not illustrated), an ElectroMyoGraphy (EMG) sensor (not illustrated), an ElectroEncephaloGram (EEG) sensor (not illustrated), an ElectroCardioGram (ECG) sensor (not illustrated), a fingerprint sensor (not illustrated), and/or the like. Additionally or alternatively, the sensor module 240 may include, for example, an E-nose sensor (not illustrated), an EMG sensor (not illustrated), an EEG sensor (not illustrated), an ECG sensor (not illustrated), a fingerprint sensor, and the like. The sensor module 240 may further include a control circuit (not illustrated) for controlling one or more sensors included therein.

The user input module 250 may include a touch panel 252, a pen sensor 254 (e.g., a digital pen sensor), keys 256, and an ultrasonic input unit 258. The user input module 250 may be, for example, the user input module 140 illustrated in FIG. 1. The touch panel 252 may recognize a touch input in at least one of, for example, a capacitive scheme, a resistive scheme, an infrared scheme, and an acoustic wave scheme. The touch panel 252 may further include a controller (not illustrated). In the capacitive type, the touch panel 252 is capable of recognizing proximity as well as a direct touch. The touch panel 252 may further include a tactile layer (not illustrated). In this event, the touch panel 252 may provide a tactile response to the user.

The pen sensor 254 (e.g., a digital pen sensor), for example, may be implemented by using a method identical or similar to a method of receiving a touch input from the user, or by using a separate sheet for recognition. For example, a key pad or a touch key may be used as the keys 256. The ultrasonic input unit 258 enables the terminal to detect a sound wave by using a microphone (e.g., a microphone 288) of the terminal through a pen generating an ultrasonic signal, and to identify data. The ultrasonic input unit 258 is capable of wireless recognition. According to an embodiment of the present disclosure, the hardware 200 may receive a user input from an external device (e.g., a network, a computer, or a server), which is connected to the communication module 230, through the communication module 230.

The display module 260 may include a panel 262 or a hologram 264. The display module 260 may be, for example, the display module 150 illustrated in FIG. 1. The panel 262 may be, for example, a Liquid Crystal Display (LCD) and an Active Matrix Organic Light Emitting Diode (AM-OLED) display, and the like. The panel 262 may be implemented so as to be, for example, flexible, transparent, or wearable. The panel 262 may include the touch panel 252 and one module. The hologram 264 may display a three-dimensional image in the air by using interference of light. According to an embodiment of the present disclosure, the display module 260 may further include a control circuit for controlling the panel 262 or the hologram 264.

The interface 270 may include, for example, a High-Definition Multimedia Interface (HDMI) 272, a Universal Serial Bus (USB) 274, a projector 276, and a D-subminiature (D-sub) 278. Additionally or alternatively, the interface 270 may include, for example, SD/Multi-Media Card (MMC) (not illustrated) or Infrared Data Association (IrDA) (not illustrated).

The audio codec 280 may bidirectionally convert between a voice and an electrical signal. The audio codec 280 may convert voice information, which is input to or output from the audio codec 280, through, for example, a speaker 282, a receiver 284, an earphone 286, the microphone 288, and/or the like.

The camera module 291 may capture an image and a moving image. According to an embodiment of the present disclosure, the camera module 291 may include one or more image sensors (e.g., a front lens or a back lens), an Image Signal Processor (ISP) (not illustrated), and a flash LED (not illustrated).

The power management module 295 may manage power of the hardware 200. Although not illustrated, the power management module 295 may include, for example, a Power Management Integrated Circuit (PMIC), a charger Integrated Circuit (IC), and/or a battery fuel gauge.

The PMIC may be mounted to, for example, an IC or a SoC semiconductor. Charging methods may be classified into a wired charging method and a wireless charging method. The charger IC may charge a battery, and may prevent an overvoltage or an overcurrent from a charger to the battery. According to an embodiment of the present disclosure, the charger IC may include a charger IC for at least one of the wired charging method and the wireless charging method. Examples of the wireless charging method may include a magnetic resonance method, a magnetic induction method, an electromagnetic method, and/or the like. Additional circuits (e.g., a coil loop, a resonance circuit, a rectifier, and/or the like) for wireless charging may be added in order to perform the wireless charging.

The battery fuel gauge may measure, for example, a residual quantity of the battery 296, or a voltage, a current or a temperature during the charging. The battery 296 may supply power by generating electricity, and may be, for example, a rechargeable battery.

The indicator 297 may indicate particular states of the hardware 200 or a part (e.g., the AP 211) of the hardware 200, for example, a booting state, a message state, a charging state, and/or the like. The motor 298 may convert an electrical signal into a mechanical vibration. The processor 210 may control the sensor module 240.

Although not illustrated, the hardware 200 may include a processing unit (e.g., a GPU) for supporting a module TV. The processing unit for supporting a module TV may process media data according to standards such as, for example, Digital Multimedia Broadcasting (DMB), Digital Video Broadcasting (DVB), media flow, and/or the like. Each of the above-described elements of the hardware 200 according to an embodiment of the present disclosure may include one or more components, and the name of the relevant element may change depending on the type of electronic device. The hardware 200 according to an embodiment of the present disclosure may include at least one of the above-described elements. Some of the above-described elements may be omitted from the hardware 200, or the hardware 200 may further include additional elements. Some of the elements of the hardware 200 according to an embodiment of the present disclosure may be combined into one entity, which may perform functions identical to those of the relevant elements before the combination.

The term “module” used in the present disclosure may refer to, for example, a unit including one or more combinations of hardware, software, and firmware. The “module” may be interchangeable with a term, such as “unit,” “logic,” “logical block,” “component,” “circuit,” or the like. The “module” may be a minimum unit of a component formed as one body or a part thereof. The “module” may be a minimum unit for performing one or more functions or a part thereof. The “module” may be implemented mechanically or electronically. For example, the “module” according to an embodiment of the present disclosure may include at least one of an Application-Specific Integrated Circuit (ASIC) chip, a Field-Programmable Gate Array (FPGA), and a programmable-logic device for performing certain operations which have been known or are to be developed in the future.

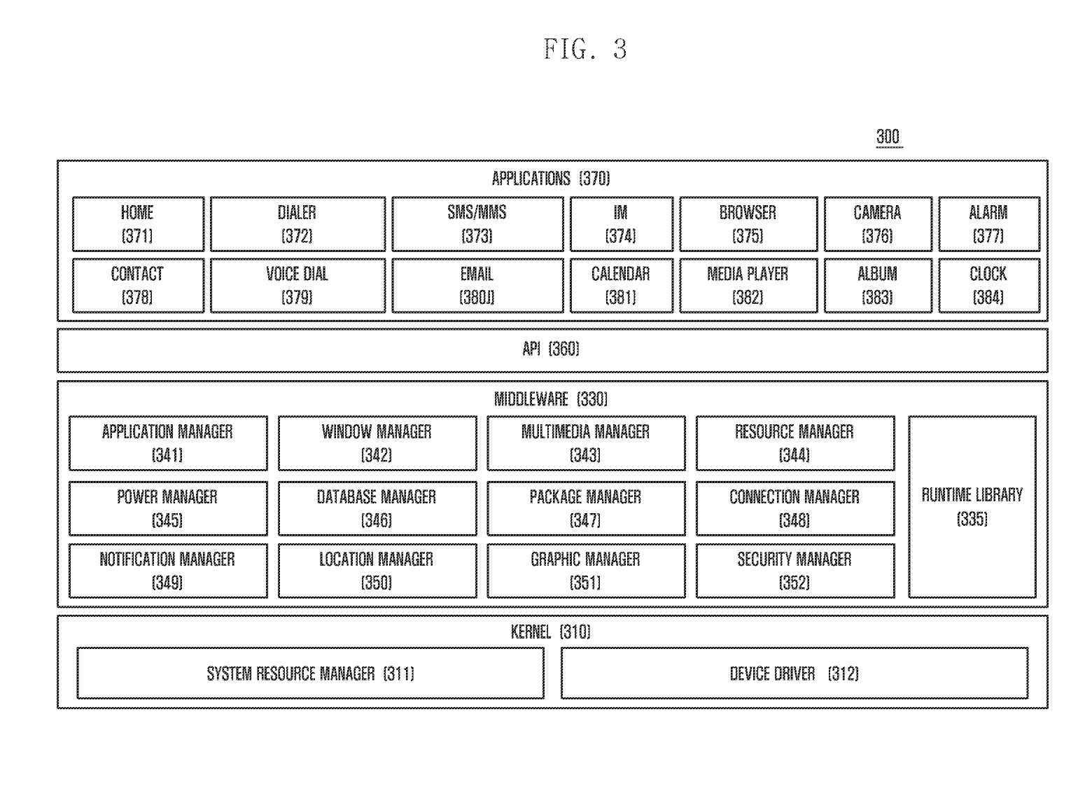

FIG. 3 is a block diagram illustrating a configuration of a programming module according to an embodiment of the present disclosure.

According to various embodiments of the present disclosure, a programming module 300 may be included (or stored) in the electronic device 100 (e.g., the memory 130) or may be included (or stored) in the electronic device 200 (e.g., the memory 230) illustrated in FIG. 1. At least a part of the programming module 300 may be implemented in software, firmware, hardware, or a combination of two or more thereof. The programming module 300 may be implemented in hardware (e.g., the hardware 200), and may include an OS controlling resources related to an electronic device (e.g., the electronic device 100) and/or various applications (e.g., an application 370) executed in the OS. For example, the OS may be Android, iOS, Windows, Symbian, Tizen, Bada, and/or the like.

Referring to FIG. 3, the programming module 300 may include a kernel 310, a middleware 330, an API 360, and/or the application 370.

The kernel 310 (e.g., the kernel 131) may include a system resource manager 311 and/or a device driver 312. The system resource manager 311 may include, for example, a process manager (not illustrated), a memory manager (not illustrated), and a file system manager (not illustrated). The system resource manager 311 may perform the control, allocation, recovery, and/or the like of system resources. The device driver 312 may include, for example, a display driver (not illustrated), a camera driver (not illustrated), a Bluetooth driver (not illustrated), a shared memory driver (not illustrated), a USB driver (not illustrated), a keypad driver (not illustrated), a Wi-Fi driver (not illustrated), and/or an audio driver (not illustrated). According to an embodiment of the present disclosure, the device driver 312 may include an Inter-Process Communication (IPC) driver (not illustrated).

The middleware 330 may include multiple modules previously implemented so as to provide a function used in common by the applications 370. The middleware 330 may provide a function to the applications 370 through the API 360 in order to enable the applications 370 to efficiently use limited system resources within the electronic device. For example, as illustrated in FIG. 3, the middleware 330 (e.g., the middleware 132) may include at least one of a runtime library 335, an application manager 341, a window manager 342, a multimedia manager 343, a resource manager 344, a power manager 345, a database manager 346, a package manager 347, a connectivity manager 348, a notification manager 349, a location manager 350, a graphic manager 351, a security manager 352, and any other suitable and/or similar manager.

The runtime library 335 may include, for example, a library module used by a complier, in order to add a new function by using a programming language during the execution of the application 370. According to an embodiment of the present disclosure, the runtime library 335 may perform functions which are related to input and output, the management of a memory, an arithmetic function, and/or the like.

The application manager 341 may manage, for example, a life cycle of at least one of the applications 370.

The window manager 342 may manage GUI resources used on the screen.

The multimedia manager 343 may detect a format used to reproduce various media files and may encode or decode a media file through a codec appropriate for the relevant format.

The resource manager 344 may manage resources, such as a source code, a memory, a storage space, and/or the like of at least one of the applications 370.

The power manager 345 may operate together with a Basic Input/Output System (BIOS), may manage a battery or power, and may provide power information and the like used for an operation.

The database manager 346 may manage a database in such a manner as to enable the generation, search and/or change of the database to be used by at least one of the applications 370.

The package manager 347 may manage the installation and/or update of an application distributed in the form of a package file.

The connectivity manager 348 may manage a wireless connectivity such as, for example, Wi-Fi and Bluetooth. The notification manager 349 may display or report, to the user, an event such as an arrival message, an appointment, a proximity alarm, and the like in such a manner as not to disturb the user. The location manager 350 may manage location information of the electronic device.

The graphic manager 351 may manage a graphic effect, which is to be provided to the user, and/or a user interface related to the graphic effect.

The security manager 352 may provide various security functions used for system security, user authentication, and the like.

According to an embodiment of the present disclosure, when the electronic device (e.g., the electronic device 100) has a telephone function, the middleware 330 may further include a telephony manager (not illustrated) for managing a voice telephony call function and/or a video telephony call function of the electronic device.

The middleware 330 may generate and use a new middleware module through various functional combinations of the above-described internal element modules. The middleware 330 may provide modules specialized according to types of OSs in order to provide differentiated functions. The middleware 330 may dynamically delete some of the existing elements, or may add new elements. Accordingly, the middleware 330 may omit some of the elements described in the various embodiments of the present disclosure, may further include other elements, or may replace the some of the elements with elements, each of which performs a similar function and has a different name.

The API 360 (e.g., the API 133) is a set of API programming functions, and may be provided with a different configuration according to an OS. In the case of Android or iOS, for example, one API set may be provided to each platform. In the case of Tizen, for example, two or more API sets may be provided to each platform.

The applications 370 (e.g., the applications 134) may include, for example, a preloaded application and/or a third party application. The applications 370 (e.g., the applications 134) may include, for example, a home application 371, a dialer application 372, a Short Message Service (SMS)/Multimedia Message Service (MMS) application 373, an Instant Message (IM) application 374, a browser application 375, a camera application 376, an alarm application 377, a contact application 378, a voice dial application 379, an electronic mail (e-mail) application 380, a calendar application 381, a media player application 382, an album application 383, a clock application 384, and any other suitable and/or similar application.

At least a part of the programming module 300 may be implemented by instructions stored in a non-transitory computer-readable storage medium. When the instructions are executed by one or more processors (e.g., the one or more processors 210), the one or more processors may perform functions corresponding to the instructions. The non-transitory computer-readable storage medium may be, for example, the memory 220. At least a part of the programming module 300 may be implemented (e.g., executed) by, for example, the one or more processors 210. At least a part of the programming module 300 may include, for example, a module, a program, a routine, a set of instructions, and/or a process for performing one or more functions.

Names of the elements of the programming module (e.g., the programming module 300) according to an embodiment of the present disclosure may change depending on the type of OS. The programming module according to an embodiment of the present disclosure may include one or more of the above-described elements. Alternatively, some of the above-described elements may be omitted from the programming module. Alternatively, the programming module may further include additional elements. The operations performed by the programming module or other elements according to an embodiment of the present disclosure may be processed in a sequential method, a parallel method, a repetitive method, or a heuristic method. Some of the operations may be omitted, or other operations may be added to the operations.

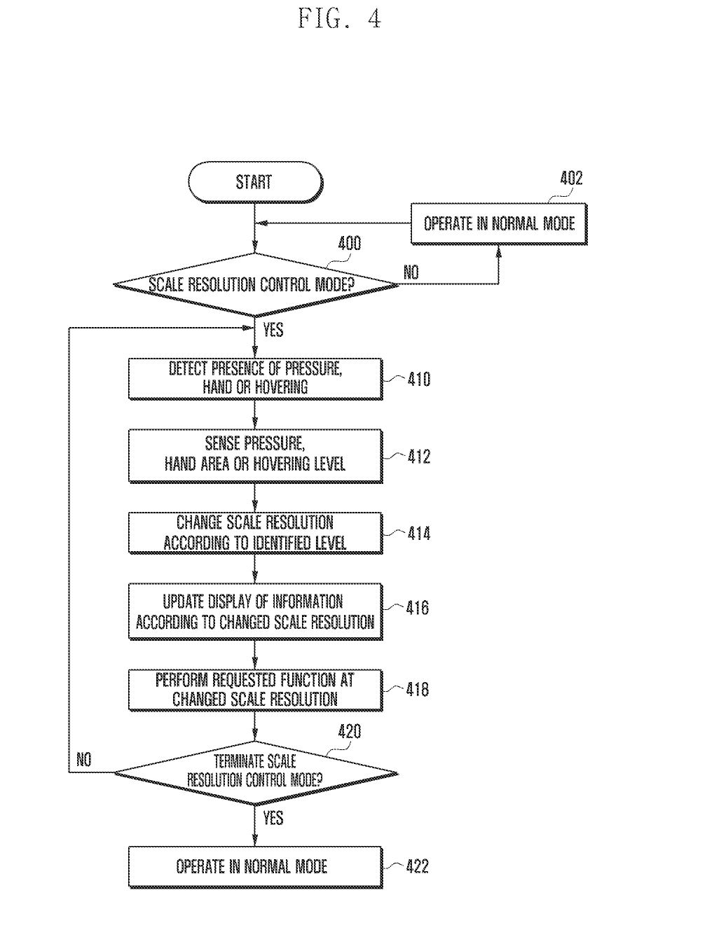

FIG. 4 is a flowchart of a method for controlling scale resolution in response to various user inputs in an electronic device according to an embodiment of the present disclosure. For ease of description, the electronic device is assumed to have a configuration depicted in FIG. 1. However, it will be apparent to those skilled in the art that the description related to FIG. 4 may also be given on the basis of a configuration identical to that of FIG. 2 or FIG. 3.

Referring to FIG. 4, at operation 400, the processor 120 of the electronic device determines whether the current mode is a scale resolution control mode. The processor 120 may also determine whether a request for a scale resolution control mode is issued by examining an input signal from at least one of the user input module 140, the camera module 291, and the display module 150. If the current mode is the scale resolution control mode, the procedure proceeds to operation 410. Otherwise, the procedure proceeds to operation 402 at which the processor 120 functions in a normal mode. In the normal mode, the processor 120 performs a requested function according to a user input. For example, a call may be placed or received; a message may be composed, sent or received; or an application (app) may be executed.

At operation 410, the processor 120 detects presence of pressure, the hand, or hovering on the basis of input signals from at least one of the user input module 140, camera module 291, and display module 150. Here, “hovering” may correspond to a state in which a pen, a part of the human body such as a finger or hand, or an instrument that can be detected by the electronic device is separated by a preset distance or less from the electronic device. Detecting at operation 410 may be associated with detection of the primary user input (first user input) described before.

To be more specific about detecting at operation 410, at least one input sensor (e.g., touch panel, pen sensor or ultrasonic key) of the user input module 140, camera module 291, and display module 150 may be used. At least one of the camera module 291, sensor module 240 (e.g., a touch sensor, a gesture sensor, an ambient light sensor, an RGB sensor, a grip sensor, a biometric sensor, an air pressure sensor, an acceleration sensor, and/or the like) and an EMR sensor may also be used. At least one of the above modules or sensors may be used to measure the pressure exerted on the user input module 140 by an electronic pen held by the user or a part of the user such as a finger or hand, to measure the area of contact between a part of the user such as a finger or hand and the user input module 140, or to measure the separation distance of an electronic pen or a part of the user such as a finger or hand from the touchscreen.

Hovering may be controlled by use of the camera module 291. For example, the camera module 291 may be used to capture an image of a part of the user such as a finger or hand; the separation distance may be computed using the image data; and the separation distance may be used to control hovering.

Hovering input may also be controlled by use of an ambient light sensor or grip sensor. For example, the ambient light sensor may be used to measure brightness variations caused by the approach of a part of the user such as a hand; the separation distance may be computed using the measured brightness variations; and the separation distance may be used to perform hovering. The grip sensor may be used to measure pressing pressure variations, and the measurement result may be used in a manner similar to the case of the ambient light sensor.

In addition, the hovering input may also be controlled by use of an acceleration sensor. For example, the acceleration sensor may be used to measure variations in the acceleration of the electronic device, and the measurement result may be used to control hovering.

In the following description, a hovering input in response to the primary user input may be performed by at least one of detecting the separation distance of the hand or pen, detecting the separation distance using a camera module, detecting the distance using an ambient light sensor, detecting the pressure using a grip sensor, detecting a variation in movement speed of the electronic device using an acceleration sensor, and measurement using an EMR sensor. However, for ease of description, it is assumed that hovering input is described as being performed by detecting the separation distance of the hand or pen in response to the primary user input.

After detecting presence of pressure, the hand or hovering, at operation 412, the processor 120 detects at least one of the pressure, hand area or hovering level. For pressure detecting, a pressure sensor contained in the user input module 140 or the display module 150 may be used. For hand area detecting, at least one of the user input module 140, display module 150, sensor module 240, and camera module 291 or at least one sensor contained therein may be used to measure variations in the area of the hand or other part of the user with or without contact. Preset hand area information may be used for hand area detecting. For hovering level detecting, the separation distance from the electronic device may be utilized.

Detecting results may be used as it is or be divided into several levels for user convenience. For example, various levels of pressure may be defined according to the sensitivity of the pressure sensor contained in the user input module 140 or display module 150. When a highly sensitive pressure sensor can have, for example, 1024 pressure values or gradations, the 1024 pressure values may be grouped into a number of levels suitable for the user, such as four, six, or eight levels. Specifically, assume that a pressure sensor can have 1024 pressure values or gradations and not all the gradations are needed by the user. When four levels of pressure are deemed to be suitable for the user, the 1024 pressure values may be evenly grouped into four levels: the first level composed of 0^{th} to 255^{th} pressure values, the second level composed of 256^{th} to 511^{th} pressure values, the third level composed of 512^{th} to 767^{th} pressure values, and the fourth level of 768^{th} to 1023^{th} pressure values.

Measurement levels may be unevenly defined according to usage inclination of the user or characteristics of the electronic device. For example, the 1024 pressure values may be unevenly grouped into four levels: the first level composed of 0^{th} to 380^{th} pressure values, the second level composed of 381^{th} to 762^{th} pressure values, the third level composed of 763^{th} to 986^{th} pressure values, and the fourth level of 987^{th} to 1023^{th} pressure values.

In the above examples, all the pressure values are used to define levels. However, not all the pressure values may be used. For instance, some of the 1024 pressure values may be grouped into four levels: the first level composed of 52^{th} to 255^{th} pressure values, the second level composed of 256^{th} to 511^{th} pressure values, the third level composed of 512^{th} to 767^{th} pressure values, and the fourth level of 768^{th} to 908^{th} pressure values. The four levels may be composed of different numbers of pressure values.

For the area deformed by a part of the user such as a finger or hand, levels for the user touched region may be defined in a manner similar to the case of the pressure sensor. For hovering, the maximum separation distance may be subdivided to define a number of levels of hovering suitable for the user. In this way, any type of detecting or measurement values may be grouped to define a suitable number of levels for the user.

Input for scale resolution control may be obtained as follows. First, when a pen like an electronic pen is supported, writing pressure of the pen may be used as input for scale resolution control. Second, the touch pressure or touch area on the touch panel of the user input module 140 may be used as input. Third, hovering sensitivity of a pen may be used as input. Fourth, hovering sensitivity detected on the touch panel of the user input module 140 may be used as input.

Meanwhile, hovering input may take various forms, such as detecting the separation distance of the hand or pen, identifying the distance of the hand or pen using a camera module, measuring the distance using an ambient light sensor, measuring pressure using a grip sensor, and detecting variations in movement speed of the electronic device using an acceleration sensor.

At operation 414, the processor 120 changes scale resolution according to the identified level. Scale resolution may be controlled differently according to the application program or app in current execution. First, a description is given of various scales of resolution control according to various embodiments of the present disclosure.

According to various embodiments of the present disclosure, one-dimensional scale resolution control may be used. According to various embodiments of the present disclosure, two-dimensional scale resolution control may be used. According to various embodiments of the present disclosure, tree-dimensional scale resolution control may be used. One-dimensional scale resolution, two-dimensional scale resolution and tree-dimensional scale resolution are described in more detail later with reference to the drawings.

At operation 416, the processor 120 changes (e.g., updates) display of information on the display module 150 according to the changed scale resolution in response to input from at least one of the user input module 140, camera module 291, and display module 150. Update of information display on the display module 150 may be performed differently according to the application program or app in current execution. The update of information display on the display module 150 is described in more detail later with reference to the drawings.

At operation 418, the processor 120 performs a requested function in response to input from the user input module 140 at the changed scale resolution. This operation is performed differently according to the application program or app in current execution, and is described in more detail later with reference to the drawings.

Thereafter, at operation 420, the processor 120 determines whether a termination request for the scale resolution control mode is issued. Such a request may be issued through at least one of the user input module 140, camera module 291 and display module 150. If a termination request for the scale resolution control mode is issued, the procedure proceeds to operation 422 at which the processor 120 functions in the normal mode.

If a termination request for the scale resolution control mode is not issued, the procedure returns to operation 410 and the processor 120 continues to function in the scale resolution control mode.

Next, a description is given of one-dimensional scale resolution, two-dimensional scale resolution and tree-dimensional scale resolution with reference to the drawings. In addition, a description is given of various embodiments wherein scale resolution is changed in response to input from an application program or app.

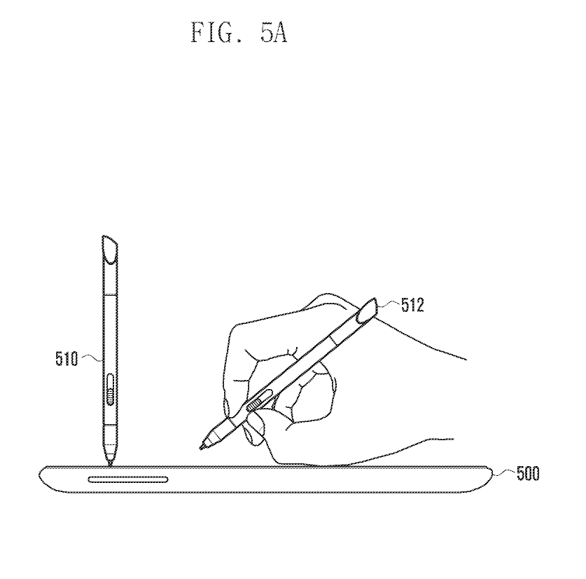

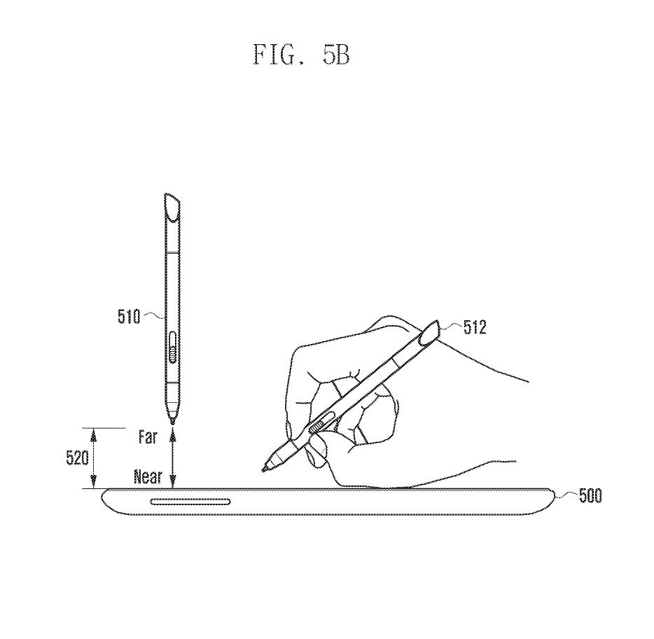

FIG. 5A illustrates one of various user input schemes according to an embodiment of the present disclosure.

Referring to FIG. 5A, an electronic device 500 (e.g., electronic device 100) and electronic pens 510 and 512 are illustrated. The electronic pen 512 represents an example of pen use by the user. For example, the electronic pen is typically used in a manner indicated by reference 512 rather than in a manner indicated by reference 510. For example, an electronic pen used by a user typically engages the surface (or area in proximity to the surface) of the electronic device 500 at an angle such that the electronic pen is not positioned perpendicular to the surface of the electronic device 500. The electronic device 500 may detect the nib of the pen being held by the user.

FIG. 5B illustrates another one of various user input schemes according to an embodiment of the present disclosure.

Referring to FIGS. 5A and 5B, contrasting input schemes are illustrated. In FIG. 5A, the pen 510 is in contact with the electronic device 500, and the electronic device 500 may detect, as a user input, writing pressure of the pen 510 or a touch gesture or movement of the user. In contrast, FIG. 5B illustrates that the pen 510 is in a hovering state, and the electronic device 500 may detect, as a user input, hovering sensitivity or movement of the pen 510. For example, as illustrated in FIG. 5B, the pen 510 is positioned a distance 520 away from the surface of the electronic device 500.

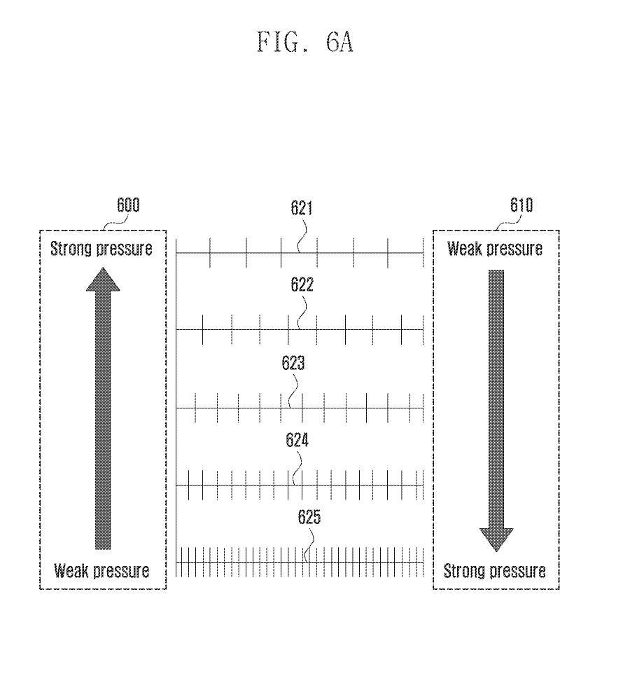

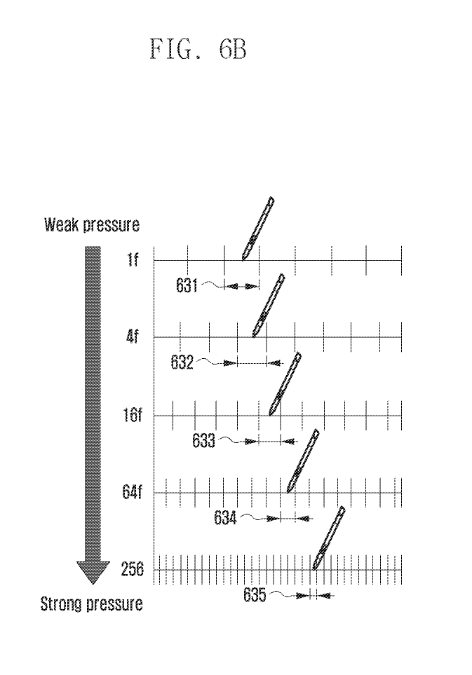

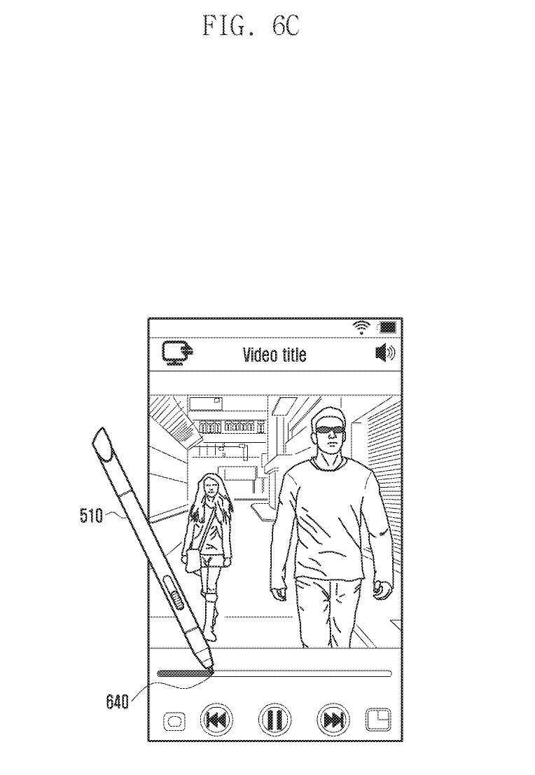

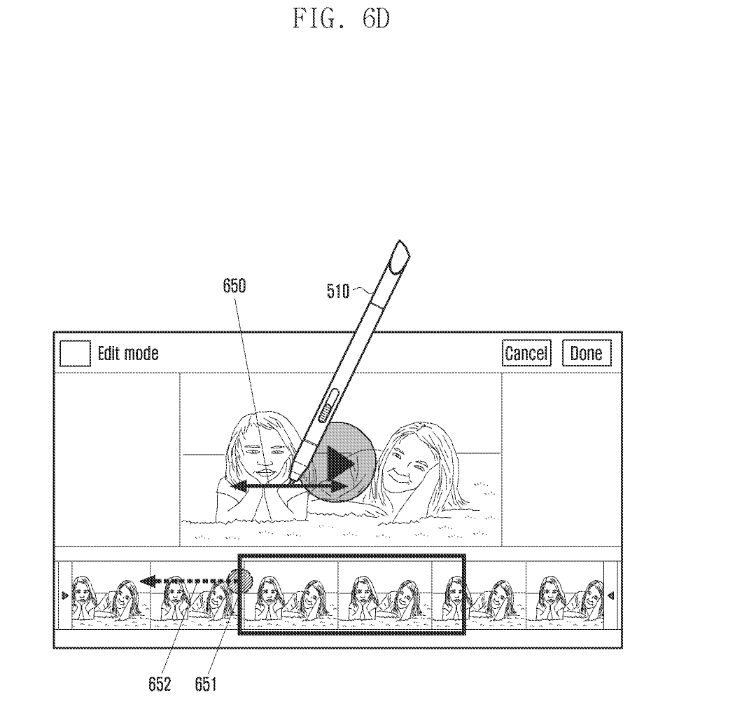

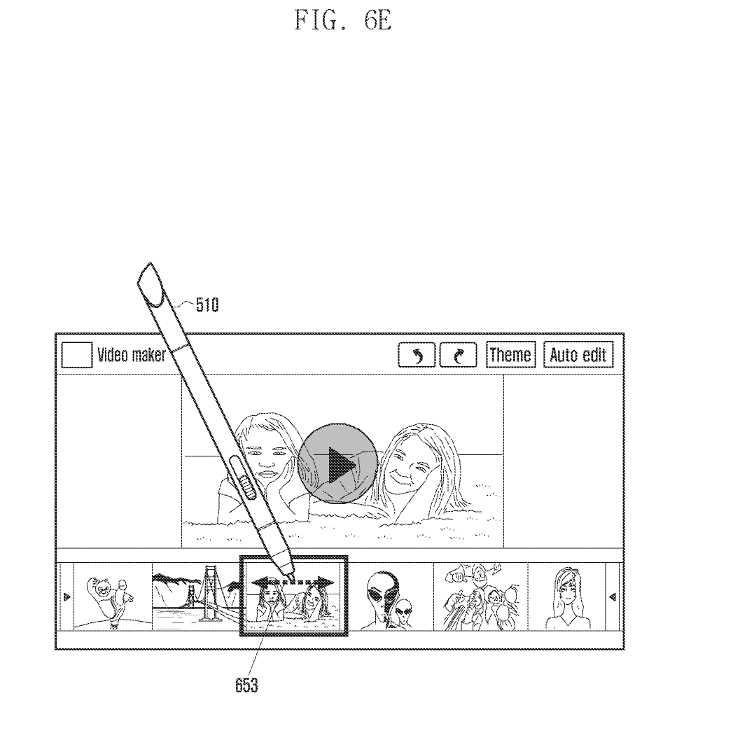

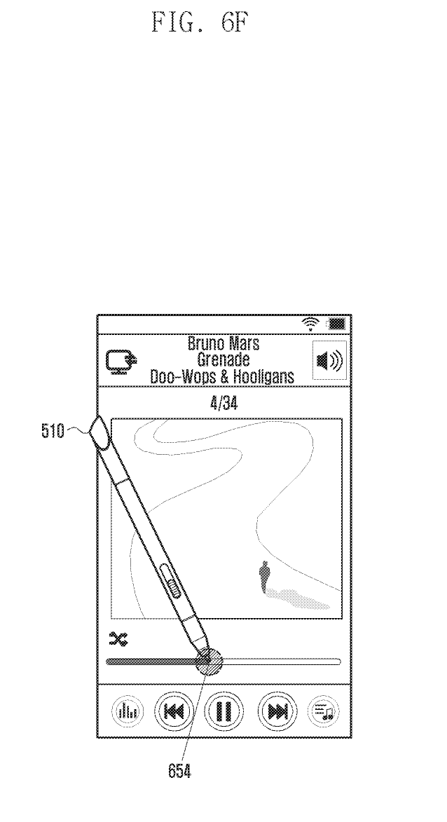

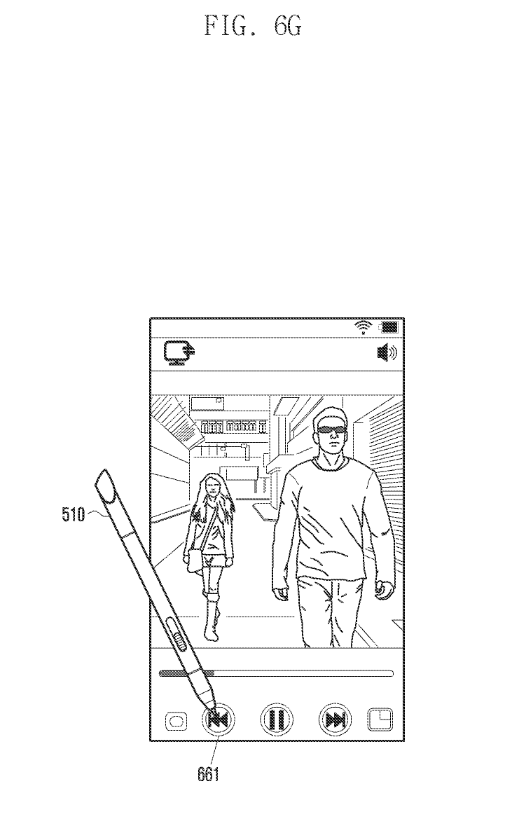

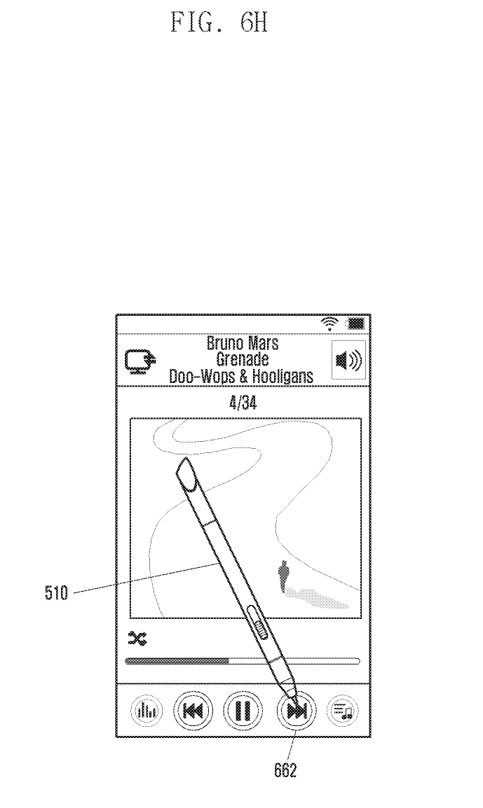

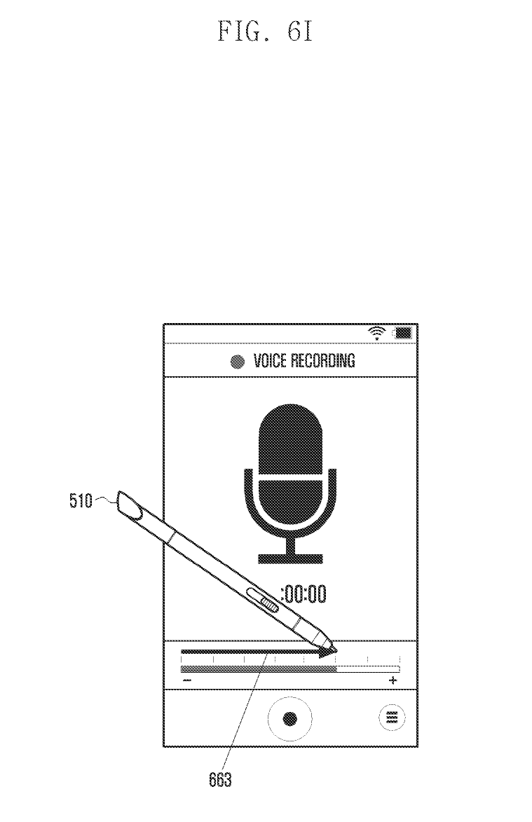

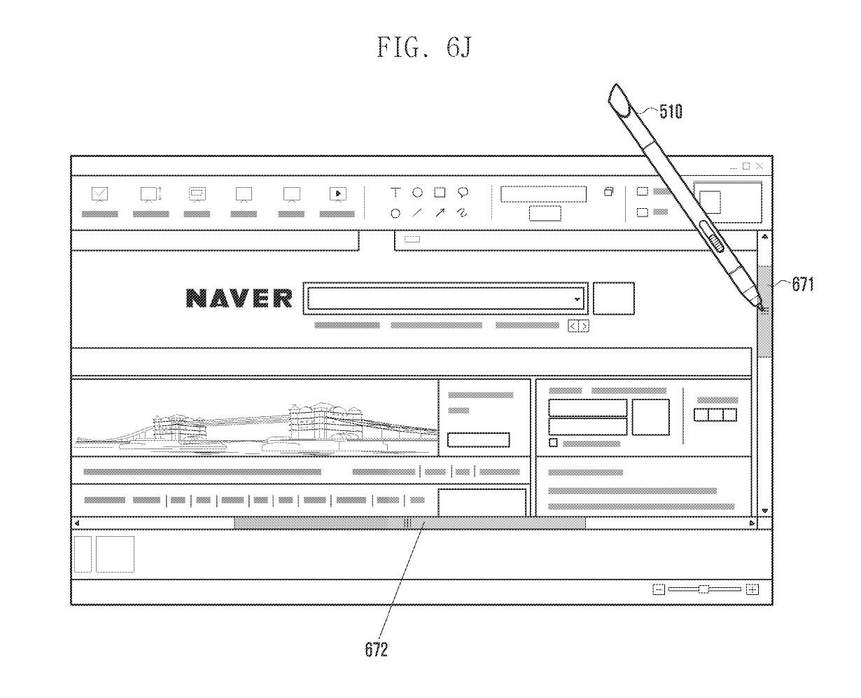

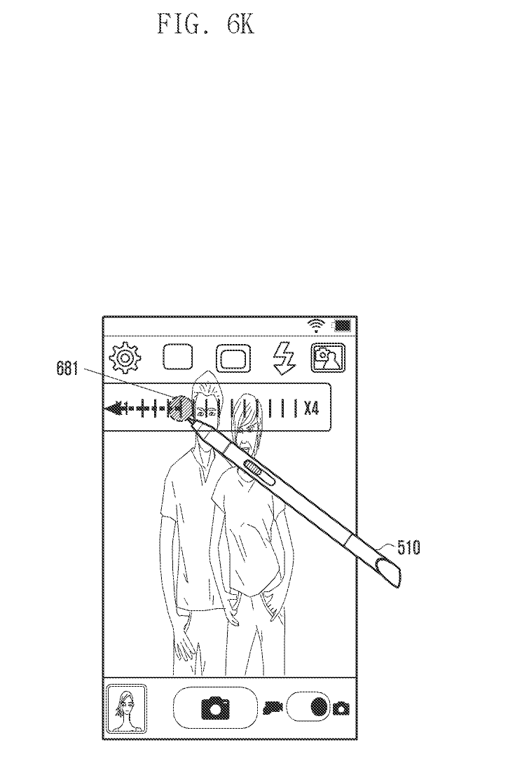

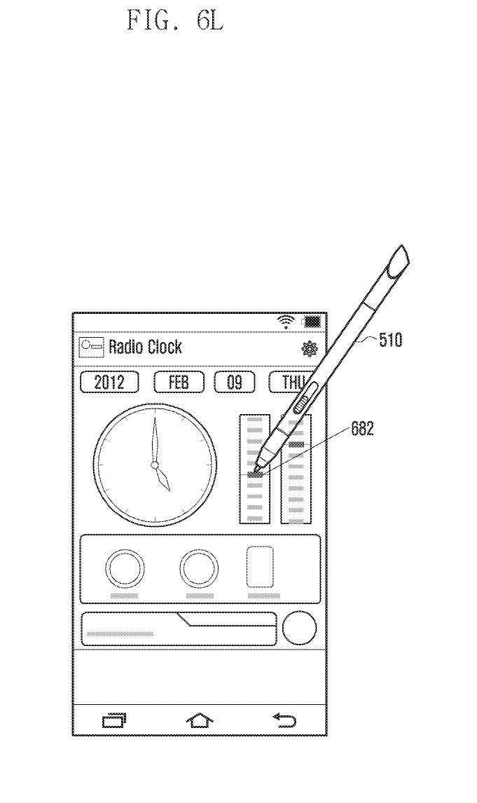

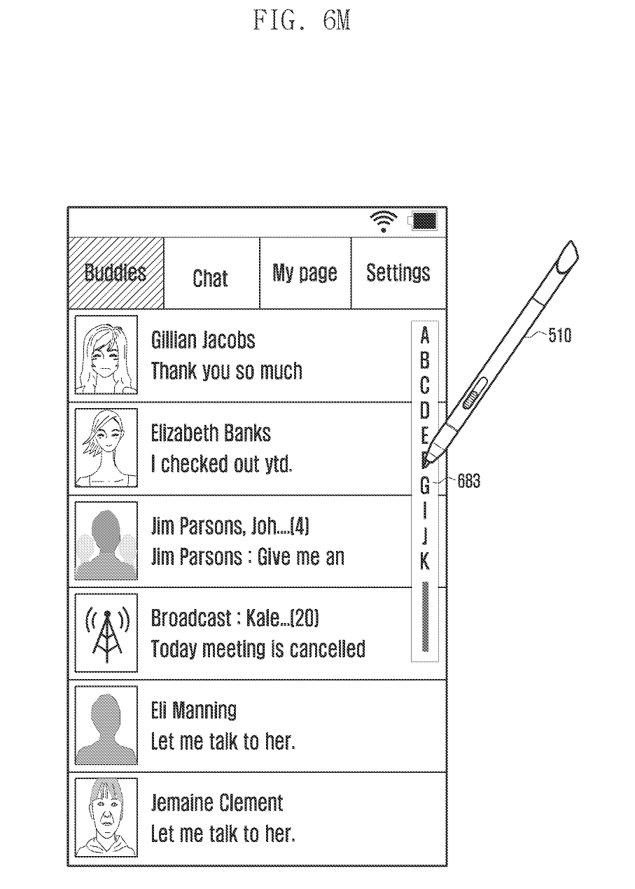

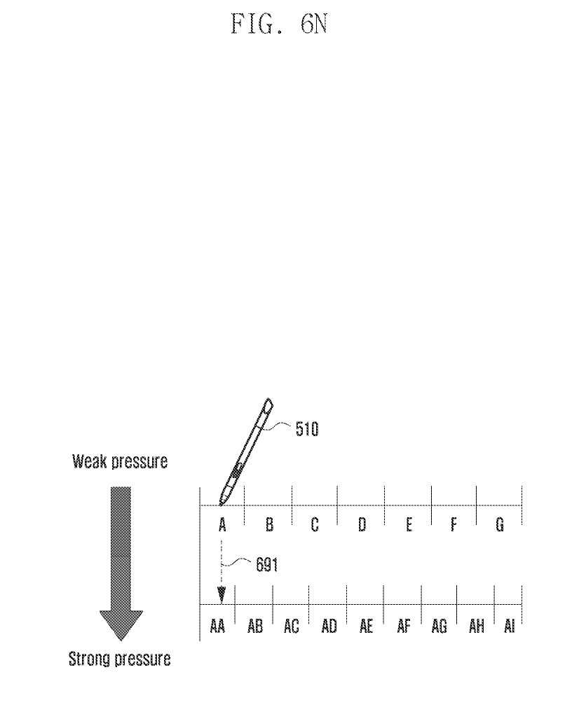

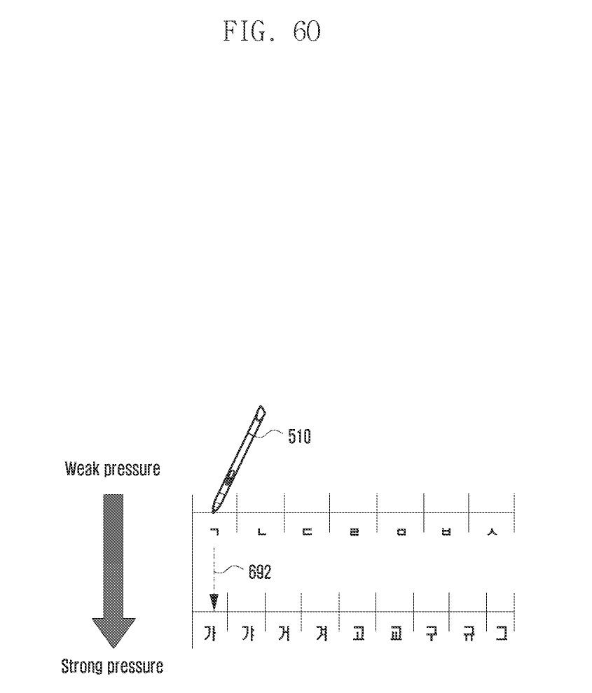

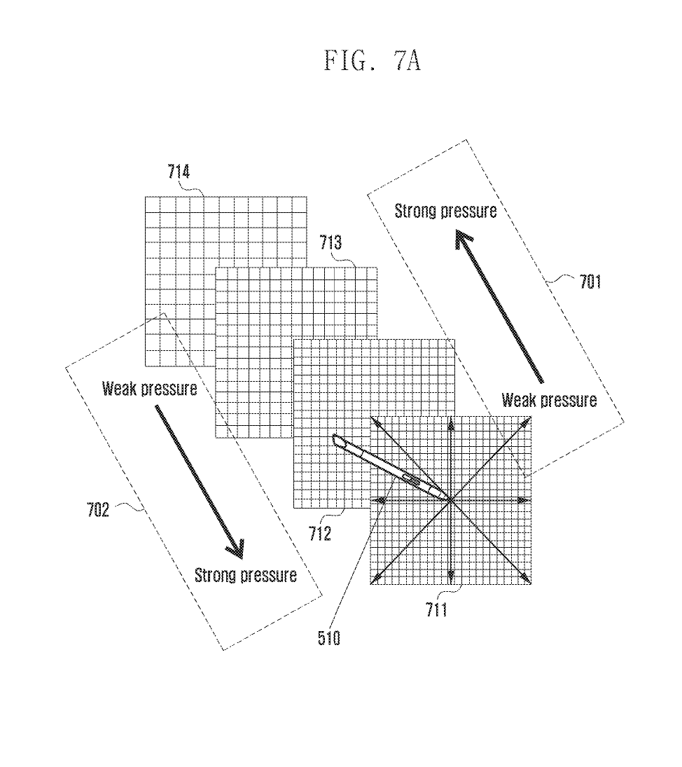

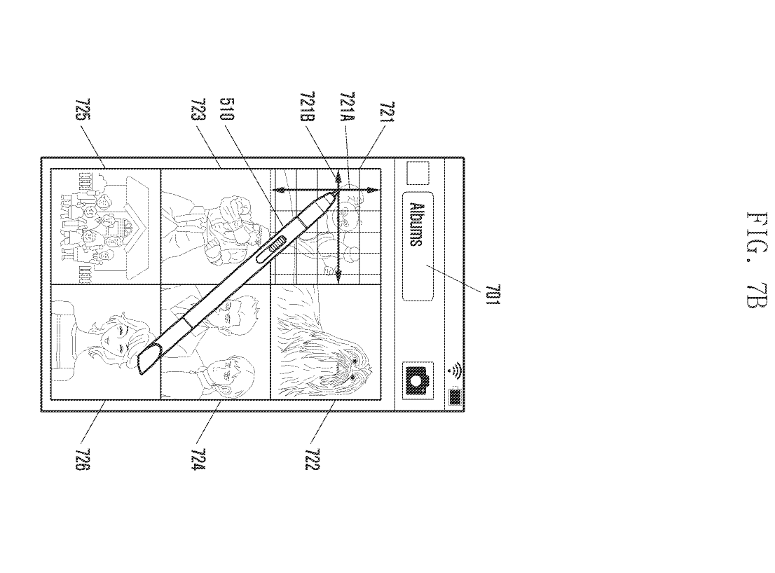

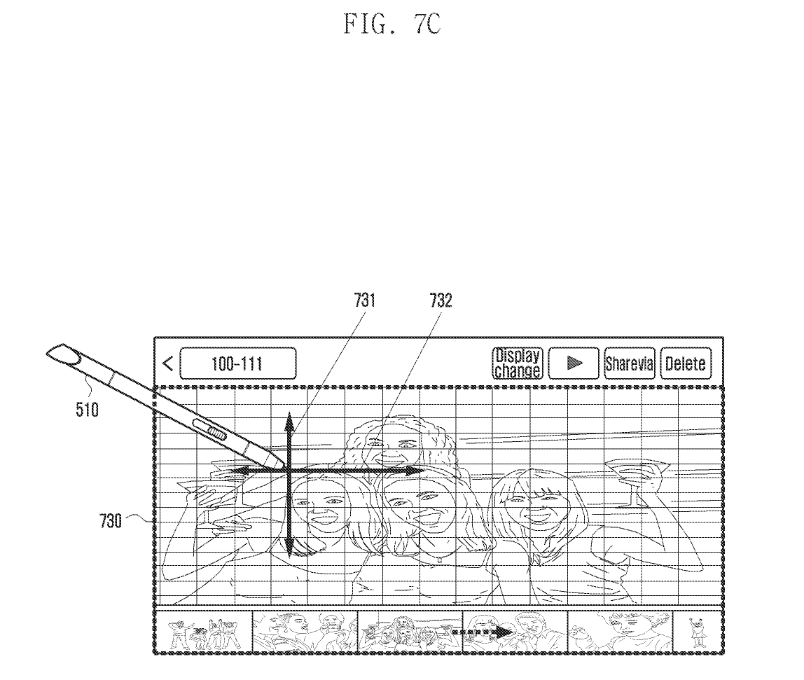

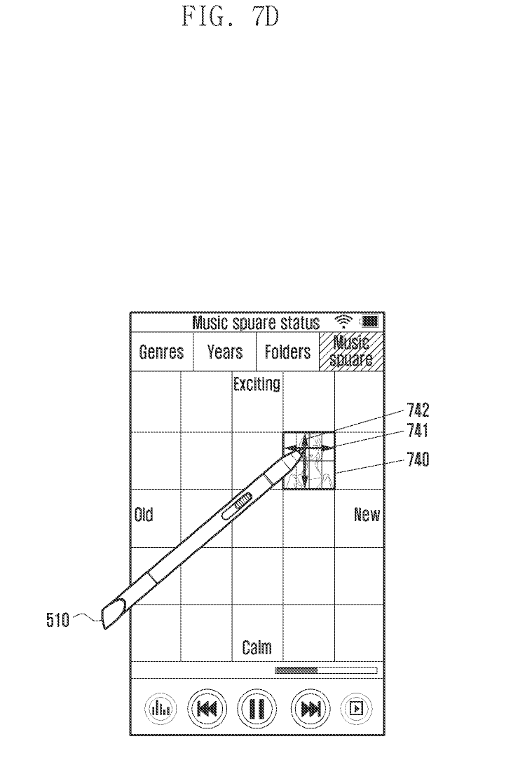

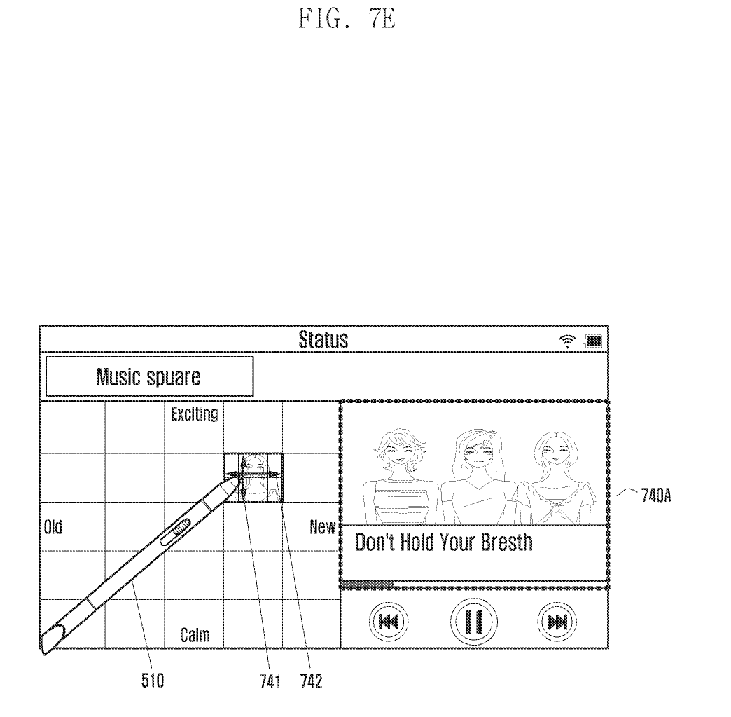

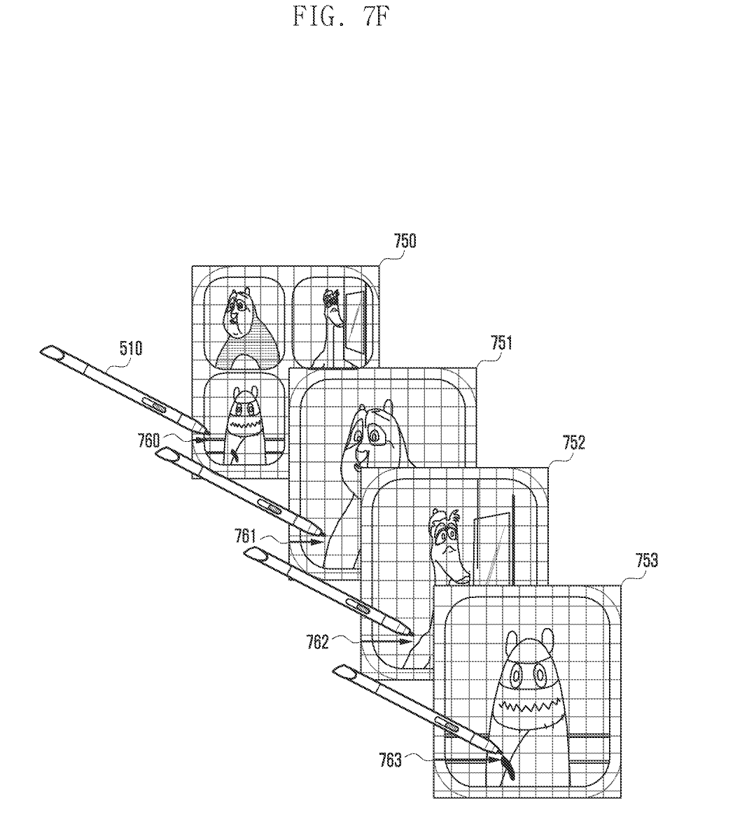

In FIGS. 6A to 6O and FIGS. 7A to 7F described below, writing pressure of a pen is used as a representative input scheme among various user input schemes. However, it will be apparent to those skilled in the art that other means such as variations in pressure due to user touch, variations in the area of contact with the electronic device, sensor input or hovering input may also be used in the following description.

As described before, hovering input may take various forms, such as detecting the separation distance of the hand or pen, identifying the distance of the hand or pen using a camera module, measuring the distance using an ambient light sensor, measuring pressure using a grip sensor, and detecting variations in movement speed of the electronic device using an acceleration sensor.

FIG. 6A illustrates variations in one dimensional scale resolution according to an embodiment of the present disclosure.

Referring to FIG. 6A, variations in writing pressure is detected to change scale resolution in one dimension. Specifically, as indicated by reference 600, configuring settings so that the interval between resolution levels becomes wider when strong pressure is detected and so that the interval between resolution levels becomes narrower when weak pressure is detected is possible. In contrast, as indicated by reference 610, configuring settings so that the interval between resolution levels becomes narrower when strong pressure is detected and so that the interval becomes wider when weak pressure is detected is possible.

For example, at the first level of pressure, the interval between resolution levels may be wide as indicated by reference 621; at the second level of pressure, the interval between resolution levels may be narrower than that at the first level of pressure as indicated by reference 622; at the third level of pressure, the interval between resolution levels may be narrower than that at the second level of pressure as indicated by reference 623; at the fourth level of pressure, the interval between resolution levels may be narrower than that at the third level of pressure as indicated by reference 624; and at the fifth level of pressure, the interval between resolution levels may be narrower than that at the fourth level of pressure as indicated by reference 625. As described above, the interval between resolution levels may be varied according to the level of pressure.

The user may configure settings in advance so that the scale resolution is varied with increasing pressure as indicated by reference 600 or with decreasing pressure as indicated by reference 610. Scale resolution becomes coarser with increasing pressure as indicated by reference 600 or becomes finer with increasing pressure as indicated by reference 610.

FIG. 6B illustrates pen movement along with variations in one dimensional scale resolution according to an embodiment of the present disclosure.

Referring to FIG. 6B, the interval between resolution levels becomes wider when pen pressure is weak and becomes narrower when pen pressure is strong. As indicated by references 631, 632, 633, 634 or 635, when the scale resolution is determined according to writing pressure, pen movement is detected in accordance with the determined scale resolution, reflecting relative sensitivity. For example, when the scale resolution is configured to sensitively vary by applying strong writing pressure, a small amount of pen movement may cause a large variation in resolution. In contrast, when the scale resolution is configured not to sensitively vary by applying weak writing pressure, a large amount of pen movement may cause just a very little variation in resolution.

The scale resolution may be determined according to initially applied writing pressure or may be configured to constantly vary according to the result of continuous monitoring of writing pressure. In the following description, phrases “determine writing pressure” or “determined writing pressure” may be related to constantly varying writing pressure or initially applied writing pressure. Phrases “determine scale resolution according to the hovering level” should be construed similarly. Scale resolution may be initially set or may be changed according to the constantly varying hovering level. The same applies to the case of using a camera module, an ambient light sensor or a grip sensor.

For example, “determined writing pressure” and “determined hovering level” may be related to “scale resolution corresponding to the currently measured writing pressure” and “scale resolution corresponding to the currently measured hovering level”, respectively. Alternatively, “determined writing pressure” and “determined hovering level” may be related to “scale resolution corresponding to the initially applied writing pressure” and “scale resolution corresponding to the initially measured hovering level”, respectively.

FIG. 6C illustrates movement in a video file along with variations in scale resolution according to an embodiment of the present disclosure.

Referring to FIG. 6C, the electronic device plays back a video file on the display module 150. By moving the pen 510 on the search bar while varying pressure applied thereto, the user may change scale resolution in the video file according to the sensitivity of the search bar 640 and perform fast search or slow search for the frame to be played back. Frame resolution is changed according to variations in pressure caused by the pen or hand, making fine control of frames in a seek mode possible.

FIG. 6D illustrates variations of scale resolution in response to a user input in a video maker edit mode according to an embodiment of the present disclosure.

Referring to FIG. 6D, the electronic device displays a video frame selected from a video file in a main display area of the display module 150 and displays preview frames (thumb nail or screen nail) below the main display area. When the user determines scale resolution by varying pressure caused by the pen 510 and moves the pen 510 at the determined scale resolution as indicated by reference 650, the frames may be shifted according to the scale resolution. Meanwhile, the scale resolution may be determined according to the initially applied writing pressure or initial hovering level, or may be continuously varied according to the current writing pressure or hovering level. Change of the scale resolution may also be achieved by use of a camera module, an ambient light sensor or a grip sensor.

For example, when the user determines scale resolution by applying pressure with the pen 510 on the video frame displayed in the main display area and moves the pen 510 as indicated by reference 650, the preview frames may be shifted at a speed given by the frame resolution corresponding to the scale resolution. The preview frames may be shifted from a position indicated by reference 651 to a position indicated by reference 652.

FIG. 6E illustrates variations of scale resolution in response to a user input in a video maker edit mode according to an embodiment of the present disclosure.

Referring to FIG. 6E, as another example, when the user determines scale resolution by varying pressure caused by the pen 510 at a given point of the preview frames and moves the pen 510 as indicated by reference 653, the frames may be shifted according to the scale resolution. Hence, the frames may be shifted fast or finely according to the pressure caused by the pen 510. Meanwhile, the scale resolution may be determined according to the initially applied writing pressure or initial hovering level, or may be continuously varied according to the current writing pressure or hovering level. Change of the scale resolution may also be achieved by use of a camera module, an ambient light sensor or a grip sensor.

As shown in FIGS. 6D and 6E, the frame resolution may be varied according to the level of pressure caused by a pen or hand, and fine control of frames in image editing using a video maker is possible. Thereby, a video file can be edited so that individual scenes are interconnected.

FIG. 6F illustrates temporal variations in scale resolution along with pen pressure and movement in a music player seek mode according to an embodiment of the present disclosure.

Referring to FIG. 6F, the electronic device displays an image associated with a music file on the display module 150 and displays a time search bar enabling position seeking in the music file. The user may touch a desired position 654 of the time search bar with a pen 510 and determine scale resolution for time search by applying suitable pressure. Meanwhile, the scale resolution may be determined according to the initially applied writing pressure or initial hovering level, or may be continuously varied according to the current writing pressure or hovering level. Change of the scale resolution may also be achieved by use of a camera module, an ambient light sensor or a grip sensor. After determining the scale resolution, when the user moves the pen 510, the music file being played back can be searched according to the determined scale resolution.

Specifically, when the user touches a position of the time search bar 654 with the pen 510, scale resolution is determined according to the touch pressure. For example, assume that the pen 510 is pressed with a weak pressure (corresponding to “1f” in FIG. 6B). In this case, as the interval between resolution levels is wide, although the pen 510 is moved a relatively long distance, the time difference between the position being played back and the position to be played back is relatively small. In other words, assume that the total play time of the music file is 04:30 (4 minutes and 30 seconds) and the current play position is 01:45. In the case of “1f” writing pressure, when a 2-cm movement of the pen corresponds to a movement of a 10-second play time, moving the pen 1 cm in the forward direction will not change the current play position. To move the play position by 20 seconds in the forward or backward direction, the pen should be moved a distance of longer than or equal to 4 cm and shorter than 6 cm. In the case of “64f” writing pressure, when a 3-mm movement of the pen corresponds to a movement of a 10-second play time, moving the pen 1 cm will move the play position by 30 seconds in the forward or backward direction.

As described above, the time resolution may be varied according to the level of pressure caused by a pen or hand, and coarse or fine control of the play time position in music played by a music player is possible.

FIG. 6G illustrates frame search during video file playback according to an embodiment of the present disclosure. FIG. 6H illustrates frame search during music file playback according to an embodiment of the present disclosure.

Referring to FIG. 6G, the electronic device plays back a video file on the display module 150. The user may touch the rewind icon 661 with a pen 510 and determine scale resolution for time search by applying suitable pressure. Meanwhile, the scale resolution may be determined according to the initially applied writing pressure or initial hovering level, or may be continuously varied according to the current writing pressure or hovering level. Change of the scale resolution may also be achieved by use of a camera module, an ambient light sensor or a grip sensor.

When the rewind icon 661 is touched, the rewind speed may be determined according to the scale resolution corresponding to the pressure exerted by the pen or hand. For example, the rewind speed may be represented by 1×, 2×, 4×, 8× or the like. The same may apply to fast forward (FWD).

Referring to FIG. 6H, the electronic device plays back a music file while displaying an image associated with the music file on the display module 150. The user may touch the fast forward icon 662 with a pen 510 and determine scale resolution for time search by applying suitable pressure. Meanwhile, the scale resolution may be determined according to the initially applied writing pressure or initial hovering level, or may be continuously varied according to the current writing pressure or hovering level. Change of the scale resolution may also be achieved by use of a camera module, an ambient light sensor or a grip sensor.

When the fast forward icon 662 is touched, the forward speed may be determined according to the scale resolution corresponding to the pressure exerted by the pen or hand. For example, the forward speed may be represented by 1×, 2×, 4×, 8× or the like. The same may apply to rewind (RWD).

As described above, the forward speed and rewind speed may be changed according to the level of pressure exerted by the pen or hand. Dynamic control of the seek speed according to the pressure exerted on the fast forward or rewind icon or button (FWD or RWD) of a video player or music player playing video or music is possible.

FIG. 6I illustrates temporal variations of scale resolution in response to a user input in a voice recorder mode according to an embodiment of the present disclosure.

Referring to FIG. 6I, the electronic device displays a voice recording state or time on the display module 150. The user may touch a desired position of the recording time bar with a pen 510 and determine scale resolution for time setting by applying suitable pressure. Meanwhile, the scale resolution may be determined according to the initially applied writing pressure or initial hovering level, or may be continuously varied according to the current writing pressure or hovering level. Change of the scale resolution may also be achieved by use of a camera module, an ambient light sensor or a grip sensor.

After determining the scale resolution, when the user moves the pen 510, the recording time may be varied according to the movement distance 663 based on the determined scale resolution. For example, the recording time may be set in advance using the pen 510. The same may apply to video recording.

FIG. 6J illustrates scroll bar control in response to a user input according to an embodiment of the present disclosure.

Referring to FIG. 6J, the electronic device displays a webpage and associated scroll bars on the display module 150. The user may touch a desired position of a scroll bar with a pen 510 and determine scale resolution for scrolling by applying suitable pressure. Meanwhile, the scale resolution may be determined according to the initially applied writing pressure or initial hovering level, or may be continuously varied according to the current writing pressure or hovering level. Change of the scale resolution may also be achieved by use of a camera module, an ambient light sensor or a grip sensor.

After determining the scale resolution, by moving the pen 510 on the scroll bar, the webpage may be moved by a distance corresponding to the pen movement distance based on the determined scale resolution. In FIG. 6J, change of scale resolution corresponding to the writing pressure may be applied to a vertical scroll bar 671 or a horizontal scroll bar 672.

FIG. 6K illustrates zooming operation control in response to a user input in a camera capture mode according to an embodiment of the present disclosure.

Referring to FIG. 6K, the electronic device displays an image captured by the camera module 291 on the display module 150. The user may touch a given position 681 with a pen 510 and change scale resolution for zooming by moving the pen 510 with suitable pressure. At this time, the electronic device may display a zoom bar having zoom level indications at the touched position along the direction of pen movement. After determining the scale resolution using the pressure exerted by the pen 510, the zoom level of the camera module 291 may be changed by moving the pen 510 on the zoom bar with suitable pressure. Hence, fast or fine change of the zoom level by moving the pen 510 in accordance with the determined scale resolution is possible. Meanwhile, the scale resolution may be determined according to the initially applied writing pressure or initial hovering level, or may be continuously varied according to the current writing pressure or hovering level. Change of the scale resolution may also be achieved by use of a camera module, an ambient light sensor or a grip sensor.

FIG. 6L illustrates variations of scale resolution in response to a user input in a clock display mode according to an embodiment of the present disclosure.

Referring to FIG. 6L, the electronic device displays current time information on the display module 150. The user may touch a desired position 682 with a pen 510 and determine scale resolution for scrolling by applying suitable pressure. After determining the scale resolution using the pressure exerted by the pen 510, the time value (e.g., hour, minute, and second) may be changed by moving the pen 510 with suitable pressure at the determine scale resolution. Meanwhile, the scale resolution may be determined according to the initially applied writing pressure or initial hovering level, or may be continuously varied according to the current writing pressure or hovering level. Change of the scale resolution may also be achieved by use of a camera module, an ambient light sensor or a grip sensor.

When the time value for the current time or alarm time is represented by hours, minutes and seconds, the scale resolution may be separately set for hours, minutes and seconds and the hour value, minute value and second value may be set according to the scale resolution. For example, in the case of a low scale resolution (“1f” in FIG. 6B), the interval between resolution levels may correspond to one second or one hour (granularity of time display: one second or one hour). When multiple clocks are displayed, configuring a setting so that the time values of the multiple clocks are changed abruptly (a number of time values at once) or smoothly (one or two time values at once) according to the pen movement distance is possible.

In addition to clock settings, in a setting mode of the electronic device, configuring a brightness or volume settings so that the brightness and/or volume settings are changed by determining the scale resolution and measuring movement distance at the scale resolution is possible.

FIG. 6M illustrates an English search mode change in response to a user input according to an embodiment of the present disclosure. FIG. 6N illustrates variations of scale resolution in an English search along with pressure according to an embodiment of the present disclosure. FIG. 6O illustrates variations of scale resolution in a Hangul search along with pressure according to an embodiment of the present disclosure.

Referring to FIG. 6M, the electronic device displays contacts of other users stored in the memory 130 on the display module 150. The user may touch the character indication bar with a pen 510 and determine scale resolution for scrolling by applying suitable pressure. Meanwhile, the scale resolution may be determined according to the initially applied writing pressure or initial hovering level, or may be continuously varied according to the current writing pressure or hovering level. Change of the scale resolution may also be achieved by use of a camera module, an ambient light sensor or a grip sensor.

Specifically, the scale resolution for character indication may be determined according to the pressure exerted on the touched position 683. Thereby, the depth for character search may be varied. The depth for character search is described in detail with reference to FIGS. 6N and 6O.

Referring to FIGS. 6N and 6O, the depth for character search may be varied according to a variation in the pressure exerted by the pen 510 as indicated by reference 691 or 692. For example, in a user interface where a list of characters is provided, the depth for character search may be adjusted according to the level of pressure exerted by the pen or hand. According to various embodiments of the present disclosure, having a large number of search indexes may be useful.

FIG. 7A illustrates variations in two dimensional scale resolution along with touch according to an embodiment of the present disclosure.

Referring to FIG. 7A, the electronic device may change the two-dimensional scale resolution according to variations in writing pressure of a pen 510. In the case of scale resolution change in two dimensions, the pen 510 is kept in contact with the electronic device.

As indicated by references 711, 712, 713 or 714, the user may determine and change the two-dimensional scale resolution by changing the writing pressure of the pen 510 and moving the pen 510 in various directions while the pen 510 is kept in contact with the electronic device. In FIG. 7A, the interval between resolution levels is fixed. However, the interval between resolution levels may be varied if necessary. Compared with one-dimensional scale resolution, movement of the pen or hand is less restricted in the two-dimensional scale resolution. For example, the scale resolution may be varied in any direction such as a horizontal, vertical, or diagonal direction.

As indicated by reference 701 or 702, the granularity in resolution may be fine or coarse when the pressure is weak.

FIG. 7B illustrates variations of two dimensional scale resolution in response to a user input during photograph previewing according to an embodiment of the present disclosure.

Referring to FIG. 7B, the electronic device displays a photo album folder 701 having a plurality of subfolders 721, 722, 723, 724, 725 and 726 on the display module 150 in a manner that the first or representative photograph of each subfolder is shown. When the folder 721 is selected with the pen 510 and the writing pressure of the pen 510 is changed, a grid pattern corresponding to the scale resolution may be displayed as indicated by references 721A and 721B.

Thereafter, when a given pressure is exerted on the pen 510, the grid pattern may be changed according to the pressure level. A dense grid pattern can indicate that a small amount of pen movement may result in scrolling of a large number of photographs; and a coarse grid pattern can indicate that a large amount of pen movement may result in scrolling of a small number of photographs.

For example, when the scale resolution is determined according to a pressure of “1f” (e.g., as illustrated in FIG. 6B), pen movement by the unit distance may result in scrolling of one of photographs stored in the folder 701. When the scale resolution is determined according to a pressure of “64f” (e.g., as illustrated in FIG. 6B), pen movement by the same distance as the case of “1f” may result in scrolling of many (e.g., 8 or 16) photographs. Many photographs scrolled together in a lump may be displayed as thumbnails (in a preview format) on the display module 150.

Meanwhile, the scale resolution may be determined according to the initially applied writing pressure or initial hovering level, or may be continuously varied according to the current writing pressure or hovering level. Change of the scale resolution may also be achieved by use of a camera module, an ambient light sensor or a grip sensor.

FIG. 7C illustrates variations of two dimensional scale resolution in response to a user input during photograph viewing according to an embodiment of the present disclosure.

Referring to FIG. 7C, the electronic device displays one photograph 730 on the display module 150. The user may determine the scale resolution for scrolling by touching a position of the photograph 730 with the pen 510 and exerting a desired level of pressure on the pen 510. Meanwhile, the scale resolution may be determined according to the initially applied writing pressure or initial hovering level, or may be continuously varied according to the current writing pressure or hovering level. Change of the scale resolution may also be achieved by use of a camera module, an ambient light sensor or a grip sensor.

As shown in FIG. 7C, a virtual grip pattern is formed on the photograph 730 according to the level of pressure exerted by the pen 510 or hand; the scale resolution is varied according to the level of exerted pressure; photographs related with the photograph 730 (included in the same folder, belonging to the same category, or selected by user preferences) are presented with movement of the pen 510 or hand; and the movement distance causing the photo view to turn to the next page may be finely controlled according to pressure adjustment. For example, two dimensional movement from the touched point as indicated by reference 731 or 732 may cause photographs, which are contained in the same folder as the photograph 730 or belong to the same category, to be scrolled fast or finely.

FIG. 7D illustrates variations of two dimensional scale resolution in response to a user input during music search according to an embodiment of the present disclosure. FIG. 7E illustrates variations of two dimensional scale resolution in response to a user input during music search according to an embodiment of the present disclosure.

Referring to FIG. 7D, the electronic device displays music files classified into categories on the display module 150. Each square displayed on the display module 150 may correspond to one folder. Referring to FIGS. 7D and 7E, a virtual grid pattern may be formed in a region associated with a specific category of songs according to the level of pressure of the pen 510 or hand, and the scale resolution may be changed according to the exerted pressure. Movement of the pen 510 or hand causes songs in the given category or album 740 to be presented at reference 740A, and the movement distance causing turning to the next song or album may be finely controlled according to pressure adjustment. For example, two dimensional movement from the touched point as indicated by reference 741 or 742 may cause song files or albums contained in the same folder to be scrolled fast or finely.

FIG. 7F illustrates variations of two dimensional scale resolution in response to a user input during folder search according to an embodiment of the present disclosure.

Referring to FIG. 7F, the electronic device displays a folder containing one or more executable files for various applications or apps on the display module 150. According to the level of pressure exerted by the pen 510 or hand, specific application files may be scrolled on the display module 150. For example, when multiple files are present in the folder as indicated by reference 750, the files may be presented as indicated by references 751, 752 and 753 according to the pressure and movement of the pen 710. The pen 510 may be moved as indicated by references 760, 761, 762 and 763 after the scale resolution is determined. Meanwhile, the scale resolution may be determined according to the initially applied writing pressure or initial hovering level, or may be continuously varied according to the current writing pressure or hovering level. Change of the scale resolution may also be achieved by use of a camera module, an ambient light sensor or a grip sensor. As described above, a virtual grid pattern may be formed around some content items contained in a folder according to the level of pressure exerted by the pen 510 or hand; the scale resolution may be changed according to the level of exerted pressure; and include items (such as apps or files) included in the folder may be scrolled in sequence and finely controlled according to movement of the pen 510 or hand.

Next, a description is given of variations in one dimensional scale resolution in a hovering state. In the hovering state, the scale resolution may be varied in one dimension according to the hovering sensitivity. The hovering sensitivity may be detected using various means, such as a magnetic sensor, ultrasonic sensor, camera, 3D image sensor (e.g., stereo camera, depth camera, or structured light scanner), touch sensor, gesture sensor, ambient light sensor, RGB sensor, grip sensor, biometric sensor, air pressure sensor, acceleration sensor, and/or the like. For example, the scale resolution may be changed according to whether the separation distance of the hand or pen is far or near. A user interface mechanism may be provided to configure settings so that the coarse or fine granularity of the scale resolution is associated with either a far distance or a near distance.

Additionally, variations of two dimensional scale resolution in the hovering state may be detected in a manner similar to the case of touch input. The interval between resolution levels may be varied evenly in horizontal or vertical direction or may be varied unevenly according to circumstances.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for controlling an electronic device, the method comprising:
presenting information on a display operatively coupled with the electronic device;
detecting a first user input related to the information;
determining a scale resolution based at least in part on the first user input; and
executing, upon detection of a second user input, a specified function based at least in part on the second user input and the scale resolution.

2. The method of claim 1, wherein the first user input and the second user input comprise orthogonal input components.

3. The method of claim 1, wherein the detecting of the first user input comprises:
Obtaining at least one of a writing pressure of a pen in contact with the electronic device, pressure of a hand in contact with the electronic device, a variation in an area of the hand, or a hovering level.

4. The method of claim 3, wherein the hovering level is measured by use of at least one of a magnetic sensor, an ultrasonic sensor, a camera module, a 3D sensor, a grip sensor, an ambient light sensor, an EMR sensor, or an acceleration sensor.

5. The method of claim 1, wherein the determining of the scale resolution comprises:
subdividing the input range of the first user input into a specified number of levels.

6. The method of claim 1, wherein the determining of the scale resolution comprises:
identifying a specified number of levels from an initial scale resolution when the information is presented.

7. The method of claim 1, further comprising:
presenting, upon determining the scale resolution, at least one of guide information related to the second user input or resolution information related to the scale resolution.

8. The method of claim 7, further comprising:
updating, in response to a change in the scale resolution, at least one of guide information related to the second user input or resolution information related to the scale resolution; and
presenting the updated information.

9. The method of claim 1, wherein the specified function corresponds to at least one of a movement on a seek bar, a movement on a progress bar, a movement of preview frames, a setting of a recording time, an enlargement/reduction, a scrolling, a volume adjustment, a brightness adjustment, a depth adjustment in character search, a music search, a photograph search, a scrolling of files, a zoom in/out, and a fast-forward/rewind.

10. The method of claim 1, wherein the second user input corresponds to at least one of movement of a pen, movement of a hand, movement of a pupil, gesture input, tilting, panning, or tapping.

11. The method of claim 1, wherein the scale resolution is determined based at least in part on a pressure of the first user input.

12. An electronic device comprising:
a display to display states of the electronic device or screen data of an executed program; and
one or more processors operatively coupled with the display, the one or more processors configured to:
detect, via the display, a first user input related to the information;
determine a scale resolution based at least in part on the first user input; and
execute, upon detection of a second user input via the display, a specified function based at least in part on the second user input and the scale resolution

13. The electronic device of claim 12, wherein the first user input and the second user input comprise orthogonal input components.

14. The electronic device of claim 12, wherein the one or more processors are configured to:
obtain at least one of a writing pressure of a pen in contact with the electronic device, a pressure of a hand in contact with the electronic device, a variation in the area of the hand, or a hovering level.

15. The electronic device of claim 14, wherein the hovering level is measured by use of at least one of a magnetic sensor, an ultrasonic sensor, a camera module, a 3D sensor, a grip sensor, an ambient light sensor, an EMR sensor, or an acceleration sensor.

16. The electronic device of claim 12, wherein the one or more processors are configured to:
subdivide the input range of the first user input into a specified number of levels at the time of determining scale resolution.

17. The electronic device of claim 12, wherein the processor identifies a specified number of levels from an initial scale resolution when the information is presented.

18. The electronic device of claim 12, wherein the processor controls, upon determining the scale resolution, the display to present at least one of guide information related to the second user input or resolution information related to the scale resolution.

19. The electronic device of claim 18, wherein the processor updates, in response to a change in the scale resolution, at least one of guide information related to the second user input or resolution information related to the scale resolution, and controls the display to present the updated information.

20. The electronic device of claim 12, wherein the specified function corresponds to at least one of a movement on a seek bar in a video player, a movement on a progress bar in a music player, a movement of preview frames in a video maker, a setting of a recording time in a voice recording program, an enlargement/reduction, a scrolling, a volume adjustment, a brightness adjustment, a depth adjustment in character search, a music search, a photograph search, a scrolling of files in a folder, a zoom in/out in a camera, and a fast-forward/rewind.

21. The electronic device of claim 12, wherein the second user input corresponds to at least one of movement of a pen, movement of a hand, movement of a pupil, gesture input, tilting, panning, and tapping.

22. The electronic device of claim 12, wherein processor determines the scale resolution based at least in part on a pressure of the first input.

23. A non-transitory computer readable storage medium storing instructions that, when executed, cause at least one processor to perform the method of claim 1.
